(19) United States
(12) Patent Application Publication
(10) Pub. No.: US 2022/0128989 A1
(43) Pub. Date: Apr. 28, 2022

(54) Systems and Methods for Providing an Improved Interface for Remote Assistance Operators

(71) Applicant: Uber Technologies, Inc., San Francisco, CA (US)

(72) Inventors: Samann Ghorbanian-Matloob, San Francisco, CA (US); Michael Guanran Huang, San Francisco, CA (US); Emily Cairns Duff Bartel, Pittsburgh, PA (US); Julien Eckstrom, San Francisco, CA (US); Güliz Tokadl?, San Francisco, CA (US); Robert Eperjesi, San Francisco, CA (US); Alex Zhukov, San Francisco, CA (US); Shanshan Zhu, San Francisco, CA (US); Ankur Toshniwal, San Francisco, CA (US)

(21) Appl. No.: 17/095,353

(22) Filed: Nov. 11, 2020

Related U.S. Application Data
(60) Provisional application No. 63/106,116, filed on Oct. 27, 2020.

(51) Int. Cl. G05D 1/00

(52) U.S. Cl. CPC G05D 1/0016; G05D 2201/0213; G05D 1/0044; G05D 1/0038

(57) ABSTRACT

Systems and methods for improving remote operator assistance for an autonomous vehicle are provided. In particular, a computing system can obtain a plurality of sensor sweeps. The computing system can receive a request for remote assistance from an autonomous vehicle. The computing system can receive real-time video data from the autonomous vehicle. The computing system can receive real-time telemetry data from the autonomous vehicle. The computing system can present the real-time video data in a remote assistance interface. The computing system can generate a graphical overlay based on the telemetry data and display it in a remote assistance user interface over the real-time video data. The computing system can display one or more remote assistance options in the remote assistance user interface. The computing system can transmit instructions to perform one or more of the remote assistance options based on input from a remote assistance operator.

This application claims priority to and the benefit of U.S. Provisional Patent Application No. 63/106,116, filed Oct. 27, 2020 which are hereby incorporated by reference in its entirety.

### FIELD

The present disclosure relates generally to autonomous vehicles. More particularly, the present disclosure relates to providing remote assistance for autonomous vehicles.

### BACKGROUND

An autonomous vehicle is a vehicle that is capable of sensing its environment and navigating without human input. In particular, an autonomous vehicle can observe its surrounding environment using a variety of sensors and can attempt to comprehend the environment by performing various processing techniques on data collected by the sensors. Given knowledge of its surrounding environment, the autonomous vehicle can identify an appropriate motion path for navigating through such a surrounding environment. The autonomous vehicle can request remote assistance if it encounters a situation in which it is unable to identify an appropriate motion path.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method can include receiving, by a computing system with one or more processors, a request for remote assistance from the autonomous vehicle. The method can include receiving, by the computing system, real-time video data from the autonomous vehicle. The method can include receiving, by the computing system, real-time telemetry data from the autonomous vehicle. The method can include generating, by the computing system, a graphical overlay based, at least in part, on the telemetry data. The method can include displaying, by the computing system and in a remote assistance user interface, the real-time video data with the graphical overlay displayed such that it is visible over the real-time video data. The method can include displaying, by the computing system, one or more remote assistance options in the remote assistance user interface, each remote assistance option is associated with a specific user interface element. The method can include transmitting, by the computing system, instructions to perform one or more of the remote assistance options based on input from a remote assistance operator.

Yet another example aspect of the present disclosure is directed to a remote assistance computing system. The computing system can receive a request for remote assistance from an autonomous vehicle, the autonomous vehicle having an associated geological position. The computing system can receive real-time video data from the autonomous vehicle. The computing system can receive real-time telemetry data from the autonomous vehicle. The computing system can access map data of the geological position associated with the autonomous vehicle. The computing system can present a remote assistance interface, the remote assistance interface including a real-time video display area and a map view area, the real-time display area displaying the real-time video data and the map view area displaying the map data associated with the autonomous vehicle. The computing system can generate a graphical overlay based, at least in part, on the telemetry data. The computing system can display, in a remote assistance user interface, the graphical overlay displayed such that it is visible over the map. The computing system can display one or more remote assistance options in the remote assistance user interface, each remote assistance option is associated with a specific user interface element. The computing system can transmit instructions to perform one or more of the remote assistance options based on input from a remote assistance operator.

Another example aspect of the present disclosure is directed to a non-transitory computer-readable medium included in a computing device. The non-transitory computer-readable medium can include instructions that cause the computing device to receive a request for remote assistance from an autonomous vehicle. The computing device can receive real-time video data from the autonomous vehicle. The computing device can receive real-time telemetry data from the autonomous vehicle. The computing device can generate a graphical overlay based, at least in part, on the telemetry data. The computing device can synchronize the real-time video data with the real-time telemetry data. The computing device can display, in a remote assistance user interface, the real-time video data with the graphical overlay displayed such that it is visible over the real-time video data and appropriately synchronized with the real-time video data. The computing device can display one or more remote assistance options in the remote assistance user interface, each remote assistance option is associated with a specific user interface element. The computing device can transmit instructions to perform one or more of the remote assistance options based on input from a remote assistance operator.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 depicts an example autonomous vehicle computing system according to example aspects of the present disclosure.

FIG. 2 depicts an example system architecture according to example aspects of the present disclosure.

FIG. 3 depicts an example of a multiple entity integration platform according to example embodiments of the present disclosure.

FIG. 4 depicts an example computing system for providing remote autonomous vehicle assistance to autonomous vehicles according to example embodiments of the present disclosure.

FIG. 5 depicts an example block diagram of a system for providing a remote assistance user interface based on received video and telemetry data according to example aspects of the present disclosure.

FIGS. 6A-6C depicts an example user interface for providing remote assistance to an autonomous vehicle according to example aspects of the present disclosure.

FIG. 7 depicts a flowchart illustrating an example method for providing remote assistance according to example embodiments of the present disclosure.

FIG. 8 depicts an example system with units for performing operations and functions according to example aspects of the present disclosure.

FIG. 9 depicts example system components according to example aspects of the present disclosure.

### DETAILED DESCRIPTION

Generally, the present disclosure is directed to providing an improved user interface for remote assistance operators when providing remote assistance to an autonomous vehicle. Generally, when an autonomous vehicle encounters a situation that it cannot handle with sufficient confidence or when requested by a passenger, the autonomous vehicle can request assistance from a remote assistance operator. The remote assistance operator needs to access data transmitted from the autonomous vehicle, interpret the situation correctly based on the accessed data, and provide useful assistance to the autonomous vehicle all within a relatively short period of time. As a result, improvements to the remote assistance user interface of the remote assistance operator can decrease the cognitive burden on the remote assistance operator and allow them to more quickly understand an issue and choose the correct response.

The autonomous vehicle can use an autonomy system to collect sensor data, predict the position and movement of objects in its environment, and generate motion plans to drive the autonomous vehicle. However, if the autonomy system is not able to confidently make a motion plan for moving forward, the autonomous vehicle can transmit a request for remote assistance. For example, a remote assistance service can be associated with the autonomous vehicle or a service entity (e.g., service provider, owner, manager, platform, etc.) associated with the autonomous vehicle. The autonomous vehicle can transmit the request directly to the remote assistance system or via an associated vehicle provider and/or service entity.

After receiving the request for remote assistance, the remote assistance system can allocate a particular remote assistance computing system associated with a particular remote assistance operator to respond to the request. The remote assistance computing system can receive a stream of real-time video data from the autonomous vehicle. This stream of real-time video data can be captured by one or more cameras included in the autonomous vehicle and can provide a view of the area around the autonomous vehicle similar to the view a driver of the autonomous vehicle would have.

The remote assistance computing system can receive real-time telemetry data from the autonomous vehicle. The telemetry data can be generated by the autonomy system and include information produced when performing the detection, prediction, and motion planning processes of the autonomous vehicle. For example, telemetry data can include information identifying one or more objects, information detailing intended motion plans of the autonomous vehicle, and measurements of one or more parameters associated with the real-time video data. The real-time video data and the real-time telemetry data can be synchronized and a graphical overlay can be generated. The graphical overlay can include one or more graphical elements that are associated with the real-time telemetry data. The graphic overlay can be displayed over the real-time video data. For example, the graphical overlay can include one or more graphical elements displaying the intended path of the autonomous vehicle on the real-time video data.

The remote assistance computing system can display a remote operator user interface. The remote operator user interface can include a real-time video display area. The remote assistance computing system can present the real-time video data in the real-time video display area with the graphical overlay presented such that one or more graphical elements from the graphical overlay are visible to the remote operate over the displayed video data. In some examples, the remote operator user interface can include a map area that displays map data. The telemetry data can be used to generate a graphical overlay for the map data as well.

The remote assistance computing system can display one or more remote assist options. Each remote assistance option represents a possible course of action for the autonomous vehicle. For example, a displayed remote assist option can be an option to follow an alternate route to avoid a particular obstacle.

A remote assistance operator can review the situation and select a remote assistance option from the one or more remote assistance options. Instructions that will cause the autonomous vehicle to perform the selected remote assistance option can be generated and transmitted to the autonomous vehicle for implementation.

An autonomous vehicle can include a vehicle computing system that performs the detection, prediction, and motion planning functions of the autonomous vehicle. The vehicle computing system can also be responsible for, among other functions, creating the control signals needed to effectively control an autonomous vehicle. The vehicle computing system can include an autonomy computing system. The autonomy computing system can include one or more systems that enable the autonomous vehicle to plan and/or follow a given route, receive sensor data about the environment, perceive objects within the vehicle's surrounding environment (e.g., other vehicles), predict the motion of the objects within the surrounding environment, and generate trajectories for the vehicle to follow based on the route/perceived objects/predicted object motion. The autonomy system can output data indicative of the generated trajectories and corresponding control signals can be sent to vehicle control system(s) (e.g., acceleration, steering, braking, etc. systems) to enable the autonomous vehicle to autonomously navigate (e.g., to its target destination).

The computing system of an autonomous vehicle can include a plurality of devices (e.g., physically-connected devices, wirelessly-connected devices, virtual devices running on a physical machine, etc.) that implement a software graph architecture of the autonomous vehicle. For instance, the computing devices can implement the vehicle's autonomy software that helps allow the vehicle to autonomously operate within its environment.

To accomplish these operations, the autonomy computing system can include, for example, a perception system, a prediction system, and a motion planning system. Many of the functions performed by the perception system, prediction system, and motion planning system can be performed, in whole or in part, by one or more machine-learning models. Moreover, one or more of the perception system, prediction system, and/or motion planning system (or the functions associated therewith) can be combined into a single system and/or share computing resources.

To help maintain awareness of the vehicle's surrounding environment, the vehicle computing system can access sensor data from one or more sensors (e.g., LIDAR, RADAR, camera, etc.) to identify static objects and/or dynamic objects (actors) in the autonomous vehicle's environment. To help determine its position within the environment (and relative to these objects), the vehicle computing system can provide sensor data to a machine-learned model(s). In addition or alternatively, the autonomous vehicle can access map data (e.g., high definition map data, etc.) to determine the autonomous vehicle's current position relative to other objects in the world (e.g., bicycles, pedestrians, other vehicles, buildings, etc.), as well as map features such as, for example, lane boundaries, curbs, and so on. In some examples, the map data can include local map data from the requesting autonomous vehicle. Local map data can include information obtained by the autonomous vehicle and stored in the local map data storage data.

The vehicle computing system can utilize the sensor data to identify one or more objects in the local environment of the autonomous vehicle. Using this sensor data, the vehicle computing system can generate perception data that describes one or more object(s) in the vicinity of the autonomous vehicle (e.g., current location, speed, heading, shape/size, sounding shape, etc.).

The generated perception data can be utilized to predict the future motion of the object(s). For example, the vehicle computing system can use the perception data to generate predictions for the movement of one or more objects as an object trajectory including one or more future coordinates/points. In some implementations, the perception and prediction functions of the vehicle computing system can be included within the same system. The vehicle computing system can use the perception data, prediction data, map data, and/or other data to generate a motion plan for the autonomous vehicle. If the vehicle computing system is unable to select an appropriate course of action for the autonomous vehicle going forward, it can generate a remote assistance request and transmit it to a remote assistance computing system.

A remote assistance can receive one or more requests for remote assistance from an autonomous vehicle (e.g., automatically generated in response to one or more detected problems) or a passenger in an autonomous vehicle (e.g., via an electronic device associated with the passenger such as a smartphone or tablet computer). By way of example, an autonomous vehicle may encounter an unexpected blockage in the way of a planned route (e.g., a fallen tree or another obstacle). The autonomous vehicle may not have a high enough confidence level to autonomously generate a new path or navigate around the obstruction.

Thus, the autonomous vehicle can send (e.g., via its onboard communication system) a communication including a request for remote assistance to the remote assistance system. Upon receiving a request for remote assistance from an autonomous vehicle, the remote assistance system can assign an operator to assist the requesting autonomous vehicle. In some example embodiments, the request for remote assistance may also be associated with particular request parameters. For example, the associated request parameters can include information identifying the specific autonomous vehicle, information about the capabilities of the vehicle, the vendor that owns the vehicle, information describing autonomous driving software that is currently operating the autonomous vehicle, and the specific remote assistance actions that are available to the remote assistance system.

In some example embodiments, the vehicle assistance request can include situational data for the autonomous vehicle. Situational data includes data describing the current situation of the vehicle including location, heading, velocity, the number and identities of passengers, and the data from any sensors included in the autonomous vehicle including but not limited to cameras, LIDAR sensors, and/or radar sensors. A specific remote assistance operator can be assigned to respond to a particular remote assistance request (e.g., a remote assistance operator familiar with the issue, the requesting vehicle, the geographic area the vehicle is located within, etc.).

The requesting autonomous vehicle can transmit data to a remote assistance system (e.g., associated with the specific remote assistance operator). For example, this data can be routed to the appropriate system via a platform associated with the coordination and management of autonomous vehicle(s) (e.g., to perform vehicle services, etc.). The remote assistance computing system can receive real-time video data that was acquired onboard the autonomous vehicle. Real-time video data can include video data captured from one or more cameras that show the situation around the autonomous vehicle as it is currently happening. In addition, the real-time video data can be captured such that it replicates (and/or exceeds) the viewing experience available to a driver of the autonomous vehicle. In this way, the remote assistance operator can analyze the situation as though they were in the autonomous vehicle itself.

The remote assistance computing system can receive (e.g., directly or indirectly), from the autonomous vehicle, real-time telemetry data. The real-time telemetry data can be real-time or at least near real-time (e.g., accounting for any processing/communication latency, etc.). Telemetry data can include data produced by the autonomy system associated with the autonomous vehicle. For example, the autonomy system can analyze sensor data (e.g., LIDAR, RADAR, etc.) to identify one or more objects. Each object can be analyzed to determine their position, pose, and object type. The telemetry data can include this information. For example, a particular object in the telemetry data can be classified as a stationary vehicle and have an associated location and heading. Another object can be classified as a bicyclist and have a current location, speed, and heading.

The telemetry data can also include data describing one or more intentions of the autonomous vehicle. For example, the currently planned route of the autonomous vehicle can be included in the telemetry data. Similarly, if the autonomous vehicle is currently considering multiple possible options going forward, the telemetry data can include intention data for each option. For example, in response to detecting an obstacle in the autonomous vehicle's path, the autonomous vehicle can consider different options including: generating a path around the obstacle, coming to a stop and waiting for the obstacle to move (e.g., if the obstacle is in motion), and pulling over to the side of the road to allow more room for the object. The intention data associated with each option can be transmitted as part of the telemetry data.

In some examples, the remote assistance computing system can access map data for the geographical location associated with the autonomous vehicle. Map data can provide detailed information about the surrounding environment of the autonomous vehicle. For example, the map data can provide information regarding: the identity and location of different roadways, road segments, buildings, or other items or objects (e.g., lampposts, crosswalks and/or curb); the location and directions of traffic lanes (e.g., the location and direction of a parking lane, a turning lane, a bicycle lane, or other lanes within a particular roadway or other travel way and/or one or more boundary markings associated therewith); traffic control data (e.g., the location and instructions of signage, traffic lights, or other traffic control devices); and/or any other map data that provides information that can assist the remote operator in processing and analyzing a situation associated with the remote assistance request.

In some examples, the remote assistance computing system can generate a remote assistance interface for presenting remote assistance data to the remote operator. The remote assistance interface can include one or more interface areas, each interface area including data displayed for the remote operator. In some examples, the remote assistance interface can include a real-time video display area. The received real-time video data can be displayed in the real-time video display area. The real-time video can include images captured by a camera associated with the autonomous vehicle. In some examples, multiple cameras can capture multiple real-time video data streams and the remote operator can switch between video data streams associated with each camera or display multiple streams of real-time video data simultaneously. In other examples, real-time video data can be captured from multiple cameras and stitched together into a panoramic view for display in the real-time video display area.

The remote assistance computing system can use the telemetry data to generate a graphical overlay to display over the video data. The graphical overlay can include a plurality of graphical elements associated with the telemetry data. For example, the graphical overlay can include graphical elements that denote a classification associated with objects displayed in the real-time video data. As a result, all stationary vehicles can be overlaid with graphical elements of a first color, whereas vehicles in motion can be overlaid with a graphical element of a second color.

Generating the graphical overlay can include determining a coordinate system for the video data displayed in the remote assistance graphical user interface. In some examples, the remote assistance computing system can use information about the position and angle of the camera providing the real-time video data, the pose of the autonomous vehicle, and information about the camera itself (e.g., field of view, etc.) to determine, what portions of the area around the autonomous vehicle are visible in the real-time video data displayed in the remote assistance interface. The remote assistance computing system can map specific areas around the autonomous vehicle to particular pixels or groups of pixels in the real-time video data display area. This mapping can be used to determine the expected location in the displayed real-time video data for objects, intentions, and measurements in the telemetry data,

In some examples, the positions of objects, intentions, and measurements in the telemetry data can be described with respect to the coordinate system associated with the autonomous vehicle. Using the mapping between the geographic area around the autonomous vehicle to specific portions of the real-time video display area, the remote assistance computing system can covert locations from the coordinate system associated with the autonomous vehicle to the corresponding location in the real-time video display area. Thus, when generating a graphical element for a particular object or location in the telemetry data, the remote assistance computing system can first transform its location into the base coordinate system of the real-time video display area and then generate an appropriately sized and position graphical element. Once all necessary elements from the telemetry data have been generated as graphic elements, the remote assistance computing system can display the graphic elements as a graphic overlay to the real-time video data. Graphic elements can represent the size, location, and position of an object, bounding shape, predicted object trajectory, planned AV trajectory, etc.

Similarly, the graphic overlay can include one or more graphical elements associated with the intentions of the autonomous vehicle. Thus, a proposed path can be displayed over the real-time video data indicating a potential further path for the autonomous vehicle. In another example, if the autonomous vehicle intends to stop at a particular point, the graphical overlay can include a graphical element representing a stopping point.

The graphical overlay can include information from the map data. Specifically, the real-time map data can include graphical elements representing the lane boundaries, traffic control elements, and other elements included in the map data. For example, a graphical element representing a stop sign or a traffic light can be displayed as an overlay over the appropriate location in the real-time video data.

The remote assistance computing system can receive the video data and the telemetry data separately in two different streams. Thus a first data stream can be real-time video data comprising a series of images captured by a sensor associated with the autonomous vehicle and transmitted to the remote assistance computing system. The second data stream can be telemetry data that represents the product of the vehicle computing system of the autonomous vehicle having performed the detection, prediction, and motion planning steps necessary to effectively control the autonomous vehicle. These two data streams can be separate and may be synchronized to be effectively displayed together.

The real-time video data can comprise a plurality of video data frames. Each frame can represent visual information from a particular point in time. The frames can each have a particular timestamp associated with them which is generated when the video frame was captured and represents that point in time.

Similarly, the telemetry data can also be a stream of data that is composed of a plurality of frames. Each frame can be associated with a particular timestamp. The autonomy system of the autonomous vehicle can subdivide all the generated telemetry data into frames such that all of the telemetry data associated with a particular period of time (e.g., 1/10 of a second) is included in a first telemetry frame and the telemetry data generated in a subsequent period of time is included in a second telemetry frame. Each telemetry frame can be associated with a particular timestamp.

Once the real-time video data and the real-time telemetry data have been received, the remote assistance computing system can synchronize the two streams such that the displayed real-time video data and the graphical overlay that is generated from the telemetry data are both representing the same period of time. To do so, the remote assistance computing system can, for a respective real-time video data frame, determine a timestamp associated with the respective real-time video data frame. Each timestamp can be associated with a particular point in time. In other examples, the timestamp can be associated with a range of time.

The remote assistance computing system can identify one or more telemetry frames with an associated timestamp that is within a predefined time period from the timestamp associated with the respective video data frame. If more than one telemetry frame has a timestamp within the predetermined threshold time period, the telemetry frame with a timestamp closest to the timestamp associated with the timestamp of the respective real-time video data frame can be selected. For example, the remote assistance computing system can determine the time associated with the real-time video data frame and determine the telemetry data frame with the closest (in time) timestamp.

The remote assistance computing system can then analyze the identified telemetry data frame to determine one or more key features within the telemetry data. As noted above, the key features can include one or more objects within the environment, one or more vehicle intentions, and one or more measurements associated with the environment of the autonomous vehicle. For example, the remote assistance computing system can identify all objects within a certain range of the autonomous vehicle. In another example, the remote assistance computing system can identify all objects of a certain type within a certain range of the autonomous vehicle.

The remote assistance computing system can, for each identified feature in the telemetry data frame, generate one or more graphical elements associated with the one or more identified features. The graphical elements can then be mapped to specific portions of the video data frame based on the information included in the video data frame and the information about the location of the one or more key features included in the telemetry data. In some examples, the graphical elements can be layered over top of the image of the object with which they are associated such that the image is partially occluded.

In some examples, the remote assistance interface displayed on the remote assistance computing system can include a map view area. The map view area can be an area of the user interface in which a map of the geographic location associated with this autonomous vehicle is displayed. In some examples, this map is generated based on map data accessed from the remote assistance computing system itself. Additionally, or alternatively, the map data can be accessed from a service provider associated with the autonomous vehicle and the remote assist computing system. Additionally, or alternatively, the map data can be received from the autonomous vehicle itself.

In some examples, the map view area can display one or more features of the geographic area including roads, lanes, buildings, signs, traffic requirements (e.g., lane directions), and so on. In some examples, the real-time telemetry data can be used to update or correct information in the map view. Thus, if the map data indicated that a stop sign was present on the particular intersection but the telemetry data determines, based on sensor data, that no such stop sign exists, the map view can be updated to show the change.

In some examples, the telemetry data can be used to generate one or more overlaid images on the map view. For example, the position of one or more vehicles or the future path of the autonomous vehicles can be displayed such that it is overlaid on the map view in the remote assistance user interface.

The remote assistance computing system can generate a user interface element that includes one or more remote assistance options. Each remote assistance option can have an associated user interface element. Interface elements can be a selectable button or other user interface element. In some examples, the remote assistance options can be at least partially based on options received from the autonomous vehicle.

In some examples, the remote assistance options can be associated with telemetry data that represent potential outcomes of selecting the specific remote assistance option. For example, if one of the remote assistance options is to navigate around an obstacle, the remote assistance option can be associated with telemetry data that can display the specific route the autonomous vehicle would take. Thus, if the remote operator interacts with that remote assistance option (e.g., by hovering over it or otherwise indicating or selecting it), the graphical interface can be updated to display graphical elements that highlight, on the real-time video data displayed in the video area, the specific route that the autonomous vehicle would follow if that remote assistance option were selected by the remote operator.

Remote assistance computers can receive, from the remote assistance operator, selection of one or more of the remote assistance options. For example, the remote assistance option operator can click on one of the options. Based on this selection, the remote assistance computer system can transmit instructions to the autonomous vehicle to perform the autonomous vehicle maneuvers associated with the selected remote assistance option.

The remote assistance computing system can record data representing which option was selected by the remote assistance operator. This data can be used to update one or more machine-learned models used by the autonomous vehicle to navigate, such that the autonomous vehicle ability to overcome obstacles can be improved.

The following provides an end-to-end example of the technology described herein. A service provider can provide a remote assistance computing system to respond to remote assistance requests from autonomous vehicles or passengers in an autonomous vehicle. The remote assistance computing system can receive a request for remote assistance from the autonomous vehicle. The remote assistance request includes information describing the current situation of the autonomous vehicle including the location of the autonomous vehicle and the information describing why the request for remote assistance was sent.

The remote assistance computing system can receive real-time video data from the autonomous vehicle. In some examples, the real-time video data, when displayed in the remote assistance user interface, can at least partially replicate the view a driver of the autonomous vehicle would have. The real-time video frame comprises a plurality of video frames, each video frame in the plurality of video frames includes timestamp data. The real-time video data can be a live or near-live display of what is currently happening near or around the requesting autonomous vehicle.

The remote assistance computing system can receive real-time telemetry data from the autonomous vehicle. This can include a direct or indirect receipt of such data. Telemetry data can include data produced by the autonomy system of the autonomous vehicle based on processing sensor data to detect its environment, predict the motion of other actors, and plan the motion of the autonomous vehicle going forward. In some examples, the telemetry data includes one or more intended actions of the autonomous vehicle. In some examples, the telemetry data includes one or more of: a classification for one or more objects in the real-time video data and a predicted measurement of at least one parameter associated with the real-time video data (e.g., information about the speed of the autonomous vehicle, a distance to a planned stop, or a distance afforded for a lane change).

The remote assistance computing system can generate a graphical overlay based, at least in part, on the telemetry data. The graphical overlay can include one or more graphic elements that can be superimposed over the real-time video data in the remote assistance user interface.

The remote assistance computing system can access map data of the geological position associated with the autonomous vehicle. The remote assistance computing system can present a remote assistance interface, the remote assistance interface including a real-time video display area and a map view area, the real-time display area displaying the real-time video data and the map view area displaying the map data associated with geographic of location the autonomous vehicle. The remote assistance computing system can display, in a remote assistance user interface, the graphical overlay displayed such that it is visible over the map data.

For example, the graphical overlay can denote the locations of predetermined parking and/or/stopping locations. This information can also include whether these locations are currently blocked or available as pick-up/drop-off zones (PDZs). In some examples, the remote assistance operator can select or otherwise interact with an element shown over the map data as a graphical overlay. In response, the remote assistance computing system can update the map view to show a rendering of a potential route/motion plan to the selected element. Thus, the map view can allow the remote assistance operator more information to determine the best course of action. In some examples, the remote assistance operator can select an element from the graphic overlay displayed over the map view and the remote assistance computing system can update the graphical overlay over the real-time video data to show a path or other selected element to the remote assistance operator from the perspective of a driver.

The remote assistance computing system can synchronize the real-time video data with the real-time telemetry data. To synchronize the real-time video data and the real-time telemetry data, the remote assistance computing system can, for a respective video frame in the plurality of video frames, identify a telemetry frame such that the timestamp data associated with the telemetry frame is within a predetermined time of the timestamp data associated with the respective video frame.

Using the identified telemetry frame, the remote assistance computing system can generate the graphical overlay to be displayed while the respective video frame is being displayed. In some examples, the graphical overlay includes a graphical representation of one or more intended actions of the autonomous vehicle. For example, a planned path can be displayed in the graphical overlap as a highlighted trajectory. In some examples, the graphical overlay includes a graphical representation of one or more of: the classification for one or more objects in the real-time video data and the predicted measurement of at least one parameter associated with the real-time video data.

In some examples, the graphical overlay can include an indication of one or more potential issues that are associated with the remote assistance request. For example, if a particular obstacle is a reason the request was sent, the remote assistance computing system can generate a graphical element that highlights the specific obstacle in the remote assistance user interface. The remote assistance computing system can display, in a remote assistance user interface, the real-time video data with the graphical overlay displayed such that it is visible over the real-time video data.

The remote assistance computing system can display one or more remote assistance options in the remote assistance user interface, each remote assistance option is associated with a specific user interface element. The remote assistance computing system can receive input from a remote assistance operator on a user interface element. For example, a remote assistance operator can click on a particular user interface element to select its associated remote assistance option. Other interactions, such as left-clicking an element or hovering over an element can cause the remote assistance computing system to display additional information or generate a graphical representation of the results of selecting a particular option (e.g., the specific route the autonomous vehicle would take).

In response to receiving input from the remote assistance operator with respect to the user interface element, the remote assistance computing system can remove one or more graphical interface elements from the graphical overlay. For example, the graphic elements associated with static objects are not needed by the remote assistance operator to choose a particular option, the remote assistance interface can include an element that allows a particular type of graphic element to be hidden or removed.

In some examples, each remote assistance option can have associated telemetry data included in the live-streamed telemetry data. For example, the telemetry data can include information describing how the autonomous vehicle will react to one or more of the remote assistance options. Thus, if the remote assistance computing system can receive user interaction from the remote assistance operator with a specific user interface element associated with a particular remote assistance option it can display additional graphical interface elements in the graphical overlay, the additional graphical interface elements being associated with the specific user interface element. Thus, the graphic overlay can be updated to display a probable stopping point if the remote assistance operator selects an option that directs the autonomous vehicle to pull over as soon as possible.

The remote assistance computing system can transmit instructions to perform one or more of the remote assistance options based on input from a remote assistance operator. In some examples, the remote assistance operator can also initiate two-way communication with one or more passengers in the autonomous vehicle.

Various means can be configured to perform the methods and processes described herein. For example, a computing system can include request receiving units(s), real-time data reception units(s), overlay generation units(s), display unit(s), transmission unit(s), and/or other means for performing the operations and functions described herein. In some implementations, one or more of the units may be implemented separately. In some implementations, one or more units may be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware.

The means can be programmed to perform one or more algorithm(s) for carrying out the operations and functions described herein. For instance, the means can be configured to receive a request for remote assistance from the autonomous vehicle. For example, a remote assistance computing system can receive a request from an autonomous vehicle that includes information about the current state of the autonomous vehicle and a particular problem to be solved. A request receiving unit is one example of a means for receiving a request for remote assistance from the autonomous vehicle.

The means can be configured to receive real-time video data from the autonomous vehicle and real-time telemetry data from the autonomous vehicle. For example, the requesting autonomous vehicle can transmit a live video feed to the remote assistance computing system as well as the telemetry data it generates in analyzing the situation. A real-time data reception unit is one example of a means for receiving real-time video data from the autonomous vehicle and real-time telemetry data from the autonomous vehicle.

The means can be configured to generate a graphical overlay based, at least in part, on the telemetry data. For example, the remote assistance computing system can generate an overlay with a plurality of graphic elements, each element serving to highlight one or more aspects of the video data that is associated with the current situation of the requesting autonomous vehicle. An overlay generation unit is one example of a means for generating a graphical overlay based, at least in part, on the telemetry data.

The means can be configured to display, in a remote assistance user interface, the real-time video data with the graphical overlay displayed such that it is visible over the real-time video data and display one or more remote assistance options in the remote assistance user interface, each remote assistance option is associated with a specific user interface element. For example, the remote assistance computing system can generate a user interface to display information to the remote assistance operator and receive input from that remote assistance operator. A display unit is one example of a means for displaying, in a remote assistance user interface, the real-time video data with the graphical overlay displayed such that it is visible over the real-time video data and displaying one or more remote assistance options in the remote assistance user interface, each remote assistance option is associated with a specific user interface element.

The means can be configured to transmit instructions to perform one or more of the remote assistance options based on input from a remote assistance operator. For example, the remote assistance computing system can, in response to the remote operator selecting a particular remote assistance option, transmit instructions to perform the selected option such that they will be received by the autonomous vehicle. A transmission unit is one example of a means for transmitting instructions to perform one or more of the remote assistance options based on input from a remote assistance operator.

The systems and methods described herein provide a number of technical effects and benefits. More particularly, the systems and methods of the present disclosure provide improved techniques for efficient situational analysis, interfacing, and communication between a service entity and an autonomous vehicle (or a passenger in an autonomous vehicle). For instance, when a request for remote assistance is received, the improved remote assistance user interface enables an operator to quickly and efficiently understand the current situation and evaluate the remote assistance actions for the situation. In this way, the updated remote assistance user interface can increase operator response speed and accuracy, increase the overall efficiency of communications and commands, and improve the reliability of such communications. This improvement in accuracy and efficiency may result in lower power use, lower processing time, and reduce mistakes made by operators. Doing so will decrease the time spent resolving the issues that result in a request for remote assistance, increase the safety of the autonomous vehicle and any passengers, and ultimately improve user experience.

The autonomous vehicle technology described herein can help improve the safety of passengers of an autonomous vehicle, improve the safety of the surroundings of the autonomous vehicle, improve the experience of the rider and/or operator of the autonomous vehicle, as well as provide other improvements as described herein. Moreover, the autonomous vehicle technology of the present disclosure can help improve the ability of an autonomous vehicle to effectively provide vehicle services to others and support the various members of the community in which the autonomous vehicle is operating, including persons with reduced mobility and/or persons that are underserved by other transportation options. Additionally, the autonomous vehicle of the present disclosure may reduce traffic congestion in communities as well as provide alternate forms of transportation that may provide environmental benefits.

With reference to the figures, example embodiments of the present disclosure will be discussed in further detail.

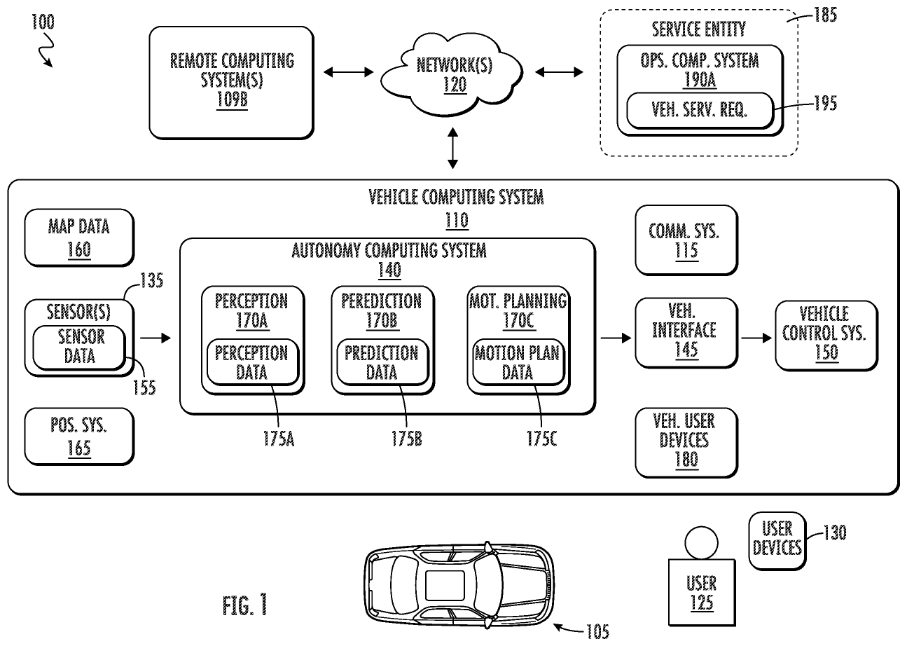

FIG. 1 depicts a block diagram of an example system 100 for controlling and communicating with a vehicle according to example aspects of the present disclosure. As illustrated, FIG. 1 shows a system 100 that can include a vehicle 105 and a vehicle computing system 110 associated with the vehicle 105. The vehicle computing system 100 can be located onboard the vehicle 105 (e.g., it can be included on and/or within the vehicle 105).

The vehicle 105 incorporating the vehicle computing system 100 can be various types of vehicles. For instance, the vehicle 105 can be an autonomous vehicle. The vehicle 105 can be a ground-based autonomous vehicle (e.g., car, truck, bus, etc.). The vehicle 105 can be an air-based autonomous vehicle (e.g., airplane, helicopter, vertical take-off and lift (VTOL) aircraft, etc.). The vehicle 105 can be a lightweight elective vehicle (e.g., bicycle, scooter, etc.). The vehicle 105 can be another type of vehicle (e.g., watercraft, etc.). The vehicle 105 can drive, navigate, operate, etc. with minimal and/or no interaction from a human operator (e.g., driver, pilot, etc.). In some implementations, a human operator can be omitted from the vehicle 105 (and/or also omitted from remote control of the vehicle 105). In some implementations, a human operator can be included in the vehicle 105.

The vehicle 105 can be configured to operate in a plurality of operating modes. The vehicle 105 can be configured to operate in a fully autonomous (e.g., self-driving) operating mode in which the vehicle 105 is controllable without user input (e.g., can drive and navigate with no input from a human operator present in the vehicle 105 and/or remote from the vehicle 105). The vehicle 105 can operate in a semi-autonomous operating mode in which the vehicle 105 can operate with some input from a human operator present in the vehicle 105 (and/or a human operator that is remote from the vehicle 105). The vehicle 105 can enter into a manual operating mode in which the vehicle 105 is fully controllable by a human operator (e.g., human driver, pilot, etc.) and can be prohibited and/or disabled (e.g., temporary, permanently, etc.) from performing autonomous navigation (e.g., autonomous driving, flying, etc.). The vehicle 105 can be configured to operate in other modes such as, for example, park and/or sleep modes (e.g., for use between tasks/actions such as waiting to provide a vehicle service, recharging, etc.). In some implementations, the vehicle 105 can implement vehicle operating assistance technology (e.g., collision mitigation system, power assist steering, etc.), for example, to help assist the human operator of the vehicle 105 (e.g., while in a manual mode, etc.).

To help maintain and switch between operating modes, the vehicle computing system 110 can store data indicative of the operating modes of the vehicle 105 in a memory onboard the vehicle 105. For example, the operating modes can be defined by an operating mode data structure (e.g., rule, list, table, etc.) that indicates one or more operating parameters for the vehicle 105, while in the particular operating mode. For example, an operating mode data structure can indicate that the vehicle 105 is to autonomously plan its motion when in the fully autonomous operating mode. The vehicle computing system 110 can access the memory when implementing an operating mode.

The operating mode of the vehicle 105 can be adjusted in a variety of manners. For example, the operating mode of the vehicle 105 can be selected remotely, off-board the vehicle 105. For example, a remote computing system (e.g., of a vehicle provider and/or service entity associated with the vehicle 105) can communicate data to the vehicle 105 instructing the vehicle 105 to enter into, exit from, maintain, etc. an operating mode. By way of example, such data can instruct the vehicle 105 to enter into the fully autonomous operating mode.

In some implementations, the operating mode of the vehicle 105 can be set onboard and/or near the vehicle 105. For example, the vehicle computing system 110 can automatically determine when and where the vehicle 105 is to enter, change, maintain, etc. a particular operating mode (e.g., without user input). Additionally, or alternatively, the operating mode of the vehicle 105 can be manually selected via one or more interfaces located onboard the vehicle 105 (e.g., key switch, button, etc.) and/or associated with a computing device proximate to the vehicle 105 (e.g., a tablet operated by authorized personnel located near the vehicle 105). In some implementations, the operating mode of the vehicle 105 can be adjusted by manipulating a series of interfaces in a particular order to cause the vehicle 105 to enter into a particular operating mode.

The vehicle computing system 110 can include one or more computing devices located onboard the vehicle 105. For example, the computing device(s) can be located on and/or within the vehicle 105. The computing device(s) can include various components for performing various operations and functions. For instance, the computing device(s) can include one or more processors and one or more tangible, non-transitory, computer readable media (e.g., memory devices, etc.). The one or more tangible, non-transitory, computer readable media can store instructions that when executed by the one or more processors cause the vehicle 105 (e.g., its computing system, one or more processors, etc.) to perform operations and functions, such as those described herein for controlling an autonomous vehicle, communicating with other computing systems, etc.

The vehicle 105 can include a communications system 115 configured to allow the vehicle computing system 110 (and its computing device(s)) to communicate with other computing devices. The communications system 115 can include any suitable components for interfacing with one or more network(s) 120, including, for example, transmitters, receivers, ports, controllers, antennas, and/or other suitable components that can help facilitate communication. In some implementations, the communications system 115 can include a plurality of components (e.g., antennas, transmitters, and/or receivers) that allow it to implement and utilize multiple-input, multiple-output (MIMO) technology and communication techniques.

The vehicle computing system 110 can use the communications system 115 to communicate with one or more computing device(s) that are remote from the vehicle 105 over one or more networks 120 (e.g., via one or more wireless signal connections). The network(s) 120 can exchange (send or receive) signals (e.g., electronic signals), data (e.g., data from a computing device), and/or other information and include any combination of various wired (e.g., twisted pair cable) and/or wireless communication mechanisms (e.g., cellular, wireless, satellite, microwave, and radio frequency) and/or any desired network topology (or topologies). For example, the network(s) 120 can include a local area network (e.g. intranet), wide area network (e.g. Internet), wireless LAN network (e.g., via Wi-Fi), cellular network, a SATCOM network, VHF network, a HF network, a WiMAX based network, and/or any other suitable communication network (or combination thereof) for transmitting data to and/or from the vehicle 105 and/or among computing systems.

In some implementations, the communications system 115 can also be configured to enable the vehicle 105 to communicate with and/or provide and/or receive data and/or signals from a remote computing device associated with a user 125 and/or an item (e.g., an item to be picked-up for a courier service). For example, the communications system 115 can allow the vehicle 105 to locate and/or exchange communications with a user device 130 of a user 125. In some implementations, the communications system 115 can allow communication among one or more of the system(s) on-board the vehicle 105.

As shown in FIG. 1, the vehicle 105 can include one or more sensors 135, an autonomy computing system 140, a vehicle interface 145, one or more vehicle control systems 150, and other systems, as described herein. One or more of these systems can be configured to communicate with one another via one or more communication channels. The communication channel(s) can include one or more data buses (e.g., controller area network (CAN)), on-board diagnostics connector (e.g., OBD-II), and/or a combination of wired and/or wireless communication links. The onboard systems can send and/or receive data, messages, signals, etc. amongst one another via the communication channel(s).

The sensor(s) 135 can be configured to acquire sensor data 155. The sensor(s) 135 can be external sensors configured to acquire external sensor data. This can include sensor data associated with the surrounding environment of the vehicle 105. The surrounding environment of the vehicle 105 can include/be represented in the field of view of the sensor(s) 135. For instance, the sensor(s) 135 can acquire image and/or other data of the environment outside of the vehicle 105 and within a range and/or field of view of one or more of the sensor(s) 135. The sensor(s) 135 can include one or more Light Detection and Ranging (LIDAR) systems, one or more Radio Detection and Ranging (RADAR) systems, one or more cameras (e.g., visible spectrum cameras, infrared cameras, etc.), one or more motion sensors, one or more audio sensors (e.g., microphones, etc.), and/or other types of imaging capture devices and/or sensors. The one or more sensors can be located on various parts of the vehicle 105 including a front side, rear side, left side, right side, top, and/or bottom of the vehicle 105. The sensor data 155 can include image data (e.g., 2D camera data, video data, etc.), RADAR data, LIDAR data (e.g., 3D point cloud data, etc.), audio data, and/or other types of data. The vehicle 105 can also include other sensors configured to acquire data associated with the vehicle 105. For example, the vehicle 105 can include inertial measurement unit(s), wheel odometry devices, and/or other sensors.

In some implementations, the sensor(s) 135 can include one or more internal sensors. The internal sensor(s) can be configured to acquire sensor data 155 associated with the interior of the vehicle 105. For example, the internal sensor(s) can include one or more cameras, one or more infrared sensors, one or more motion sensors, one or more weight sensors (e.g., in a seat, in a trunk, etc.), and/or other types of sensors. The sensor data 155 acquired via the internal sensor(s) can include, for example, image data indicative of a position of a passenger or item located within the interior (e.g., cabin, trunk, etc.) of the vehicle 105. This information can be used, for example, to ensure the safety of the passenger, to prevent an item from being left by a passenger, confirm the cleanliness of the vehicle 105, remotely assist a passenger, etc.

In some implementations, the sensor data 155 can be indicative of one or more objects within the surrounding environment of the vehicle 105. The object(s) can include, for example, vehicles, pedestrians, bicycles, and/or other objects. The object(s) can be located in front of, to the rear of, to the side of, above, below the vehicle 105, etc. The sensor data 155 can be indicative of locations associated with the object(s) within the surrounding environment of the vehicle 105 at one or more times. The object(s) can be static objects (e.g., not in motion) and/or dynamic objects/actors (e.g., in motion or likely to be in motion) in the vehicle's environment. The sensor(s) 135 can provide the sensor data 155 to the autonomy computing system 140.

In addition to the sensor data 155, the autonomy computing system 140 can obtain map data 160. The map data 160 can provide detailed information about the surrounding environment of the vehicle 105 and/or the geographic area in which the vehicle was, is, and/or will be located. For example, the map data 160 can provide information regarding: the identity and location of different roadways, road segments, buildings, or other items or objects (e.g., lampposts, crosswalks and/or curb); the location and directions of traffic lanes (e.g., the location and direction of a parking lane, a turning lane, a bicycle lane, or other lanes within a particular roadway or other travel way and/or one or more boundary markings associated therewith); traffic control data (e.g., the location and instructions of signage, traffic lights, and/or other traffic control devices); obstruction information (e.g., temporary or permanent blockages, etc.); event data (e.g., road closures/traffic rule alterations due to parades, concerts, sporting events, etc.); nominal vehicle path data (e.g., indicate of an ideal vehicle path such as along the center of a certain lane, etc.); and/or any other map data that provides information that assists the vehicle computing system 110 in processing, analyzing, and perceiving its surrounding environment and its relationship thereto. In some implementations, the map data 160 can include high definition map data. In some implementations, the map data 160 can include sparse map data indicative of a limited number of environmental features (e.g., lane boundaries, etc.). In some implementations, the map data can be limited to geographic area(s) and/or operating domains in which the vehicle 105 (or autonomous vehicles generally) may travel (e.g., due to legal/regulatory constraints, autonomy capabilities, and/or other factors).

The vehicle 105 can include a positioning system 165. The positioning system 165 can determine a current position of the vehicle 105. This can help the vehicle 105 localize itself within its environment. The positioning system 165 can be any device or circuitry for analyzing the position of the vehicle 105. For example, the positioning system 165 can determine position by using one or more of inertial sensors (e.g., inertial measurement unit(s), etc.), a satellite positioning system, based on IP address, by using triangulation and/or proximity to network access points or other network components (e.g., cellular towers, WIFI access points, etc.) and/or other suitable techniques. The position of the vehicle 105 can be used by various systems of the vehicle computing system 110 and/or provided to a remote computing system. For example, the map data 160 can provide the vehicle 105 relative positions of the elements of a surrounding environment of the vehicle 105. The vehicle 105 can identify its position within the surrounding environment (e.g., across six axes, etc.) based at least in part on the map data 160. For example, the vehicle computing system 110 can process the sensor data 155 (e.g., LIDAR data, camera data, etc.) to match it to a map of the surrounding environment to get an understanding of the vehicle's position within that environment. Data indicative of the vehicle's position can be stored, communicated to, and/or otherwise obtained by the autonomy computing system 140.

The autonomy computing system 140 can perform various functions for autonomously operating the vehicle 105. For example, the autonomy computing system 140 can perform the following functions: perception 170A, prediction 170B, and motion planning 170C. For example, the autonomy computing system 140 can obtain the sensor data 155 via the sensor(s) 135, process the sensor data 155 (and/or other data) to perceive its surrounding environment, predict the motion of objects within the surrounding environment, and generate an appropriate motion plan through such surrounding environment. In some implementations, these autonomy functions can be performed by one or more sub-systems such as, for example, a perception system, a prediction system, a motion planning system, and/or other systems that cooperate to perceive the surrounding environment of the vehicle 105 and determine a motion plan for controlling the motion of the vehicle 105 accordingly. In some implementations, one or more of the perception, prediction, and/or motion planning functions 170A, 170B, 170C can be performed by (and/or combined into) the same system and/or via shared computing resources. In some implementations, one or more of these functions can be performed via different sub-systems. As further described herein, the autonomy computing system 140 can communicate with the one or more vehicle control systems 150 to operate the vehicle 105 according to the motion plan (e.g., via the vehicle interface 145, etc.).

The vehicle computing system 110 (e.g., the autonomy computing system 140) can identify one or more objects within the surrounding environment of the vehicle 105 based at least in part on the sensor data from the sensors 135 and/or the map data 160. The objects perceived within the surrounding environment can be those within the field of view of the sensor(s) 135 and/or predicted to be occluded from the sensor(s) 135. This can include object(s) not in motion or not predicted to move (static objects) and/or object(s) in motion or predicted to be in motion (dynamic objects/actors). The vehicle computing system 110 (e.g., performing the perception function 170C, using a perception system, etc.) can process the sensor data 155, the map data 160, etc. to obtain perception data 175A. The vehicle computing system 110 can generate perception data 175A that is indicative of one or more states (e.g., current and/or past state(s)) of one or more objects that are within a surrounding environment of the vehicle 105. For example, the perception data 175A for each object can describe (e.g., for a given time, time period) an estimate of the object's: current and/or past location (also referred to as position); current and/or past speed/velocity; current and/or past acceleration; current and/or past heading; current and/or past orientation; size/footprint (e.g., as represented by a bounding shape, object highlighting, etc.); class (e.g., pedestrian class vs. vehicle class vs. bicycle class, etc.), the uncertainties associated therewith, and/or other state information. The vehicle computing system 110 can utilize one or more algorithms and/or machine-learned model(s) that are configured to identify object(s) based at least in part on the sensor data 155. This can include, for example, one or more neural networks trained to identify object(s) within the surrounding environment of the vehicle 105 and the state data associated therewith. The perception data 175A can be utilized for the prediction function 170B of the autonomy computing system 140.

The vehicle computing system 110 can be configured to predict a motion of the object(s) within the surrounding environment of the vehicle 105. For instance, the vehicle computing system 110 can generate prediction data 175B associated with such object(s). The prediction data 175B can be indicative of one or more predicted future locations of each respective object. For example, the prediction system 170B can determine a predicted motion trajectory along which a respective object is predicted to travel over time. A predicted motion trajectory can be indicative of a path that the object is predicted to traverse and an associated timing with which the object is predicted to travel along the path. The predicted path can include and/or be made up of a plurality of way points. In some implementations, the prediction data 175B can be indicative of the speed and/or acceleration at which the respective object is predicted to travel along its associated predicted motion trajectory. The vehicle computing system 110 can utilize one or more algorithms and/or machine-learned model(s) that are configured to predict the future motion of object(s) based at least in part on the sensor data 155, the perception data 175A, map data 160, and/or other data. This can include, for example, one or more neural networks trained to predict the motion of the object(s) within the surrounding environment of the vehicle 105 based at least in part on the past and/or current state(s) of those objects as well as the environment in which the objects are located (e.g., the lane boundary in which it is travelling, etc.). The prediction data 175B can be utilized for the motion planning function 170C of the autonomy computing system 140.

The vehicle computing system 110 can determine a motion plan for the vehicle 105 based at least in part on the perception data 175A, the prediction data 175B, and/or other data. For example, the vehicle computing system 110 can generate motion planning data 175C indicative of a motion plan. The motion plan can include vehicle actions (e.g., speed(s), acceleration(s), other actions, etc.) with respect to one or more of the objects within the surrounding environment of the vehicle 105 as well as the objects' predicted movements. The motion plan can include one or more vehicle motion trajectories that indicate a path for the vehicle 105 to follow. A vehicle motion trajectory can be of a certain length and/or time range. A vehicle motion trajectory can be defined by one or more waypoints (with associated coordinates). The planned vehicle motion trajectories can indicate the path the vehicle 105 is to follow as it traverses a route from one location to another. Thus, the vehicle computing system 110 can consider a route/route data when performing the motion planning function 170C.

The motion planning function 170C can implement an optimization algorithm, machine-learned model, etc. that considers cost data associated with a vehicle action as well as other objective functions (e.g., cost functions based on speed limits, traffic lights, etc.), if any, to determine optimized variables that make up the motion plan. The vehicle computing system 110 can determine that the vehicle 105 can perform a certain action (e.g., pass an object, etc.) without increasing the potential risk to the vehicle 105 and/or violating any traffic laws (e.g., speed limits, lane boundaries, signage, etc.). For instance, the vehicle computing system 110 can evaluate the predicted motion trajectories of one or more objects during its cost data analysis to help determine an optimized vehicle trajectory through the surrounding environment. The motion planning function 170C can generate cost data associated with such trajectories. In some implementations, one or more of the predicted motion trajectories and/or perceived objects may not ultimately change the motion of the vehicle 105 (e.g., due to an overriding factor). In some implementations, the motion plan may define the vehicle's motion such that the vehicle 105 avoids the object(s), reduces speed to give more leeway to one or more of the object(s), proceeds cautiously, performs a stopping action, passes an object, queues behind/in front of an object, etc.

The vehicle computing system 110 can be configured to continuously update the vehicle's motion plan and a corresponding planned vehicle motion trajectory. For example, in some implementations, the vehicle computing system 110 can generate new motion planning data 175C/motion plan(s) for the vehicle 105 (e.g., multiple times per second, etc.). Each new motion plan can describe a motion of the vehicle 105 over the next planning period (e.g., next several seconds, etc.). Moreover, a new motion plan may include a new planned vehicle motion trajectory. Thus, in some implementations, the vehicle computing system 110 can continuously operate to revise or otherwise generate a short-term motion plan based on the currently available data. Once the optimization planner has identified the optimal motion plan (or some other iterative break occurs), the optimal motion plan (and the planned motion trajectory) can be selected and executed by the vehicle 105.

The vehicle computing system 110 can cause the vehicle 105 to initiate a motion control in accordance with at least a portion of the motion planning data 175C. A motion control can be an operation, action, etc. that is associated with controlling the motion of the vehicle 105. For instance, the motion planning data 175C can be provided to the vehicle control system(s) 150 of the vehicle 105. The vehicle control system(s) 150 can be associated with a vehicle interface 145 that is configured to implement a motion plan. The vehicle interface 145 can serve as an interface/conduit between the autonomy computing system 140 and the vehicle control systems 150 of the vehicle 105 and any electrical/mechanical controllers associated therewith. The vehicle interface 145 can, for example, translate a motion plan into instructions for the appropriate vehicle control component (e.g., acceleration control, brake control, steering control, etc.). By way of example, the vehicle interface 145 can translate a determined motion plan into instructions to adjust the steering of the vehicle 105 “X” degrees, apply a certain magnitude of braking force, increase/decrease speed, etc. The vehicle interface 145 can help facilitate the responsible vehicle control (e.g., braking control system, steering control system, acceleration control system, etc.) to execute the instructions and implement a motion plan (e.g., by sending control signal(s), making the translated plan available, etc.). This can allow the vehicle 105 to autonomously travel within the vehicle's surrounding environment.

The vehicle computing system 110 can store other types of data. For example, an indication, record, and/or other data indicative of the state of the vehicle (e.g., its location, motion trajectory, health information, etc.), the state of one or more users (e.g., passengers, operators, etc.) of the vehicle, and/or the state of an environment including one or more objects (e.g., the physical dimensions and/or appearance of the one or more objects, locations, predicted motion, etc.) can be stored locally in one or more memory devices of the vehicle 105. Additionally, the vehicle 105 can communicate data indicative of the state of the vehicle, the state of one or more passengers of the vehicle, and/or the state of an environment to a computing system that is remote from the vehicle 105, which can store such information in one or more memories remote from the vehicle 105. Moreover, the vehicle 105 can provide any of the data created and/or store onboard the vehicle 105 to another vehicle.

The vehicle computing system 110 can include the one or more vehicle user devices 180. For example, the vehicle computing system 110 can include one or more user devices with one or more display devices located onboard the vehicle 105. A display device (e.g., screen of a tablet, laptop, and/or smartphone) can be viewable by a user of the vehicle 105 that is located in the front of the vehicle 105 (e.g., driver's seat, front passenger seat). Additionally, or alternatively, a display device can be viewable by a user of the vehicle 105 that is located in the rear of the vehicle 105 (e.g., a back-passenger seat). The user device(s) associated with the display devices can be any type of user device such as, for example, a table, mobile phone, laptop, etc. The vehicle user device(s) 180 can be configured to function as human-machine interfaces. For example, the vehicle user device(s) 180 can be configured to obtain user input, which can then be utilized by the vehicle computing system 110 and/or another computing system (e.g., a remote computing system, etc.). For example, a user (e.g., a passenger for transportation service, a vehicle operator, etc.) of vehicle 105 can provide user input to adjust a destination location of vehicle 105. The vehicle computing system 110 and/or another computing system can update the destination location of the vehicle 105 and the route associated therewith to reflect the change indicated by the user input.

The vehicle 105 can be configured to perform vehicle services for one or a plurality of different service entities 185. A vehicle 105 can perform a vehicle service by, for example and as further described herein, travelling (e.g., traveling autonomously) to a location associated with a requested vehicle service, allowing user(s) and/or item(s) to board or otherwise enter the vehicle 105, transporting the user(s) and/or item(s), allowing the user(s) and/or item(s) to deboard or otherwise exit the vehicle 105, etc. In this way, the vehicle 105 can provide the vehicle service(s) for a service entity to a user.

A service entity 185 can be associated with the provision of one or more vehicle services. For example, a service entity can be an individual, a group of individuals, a company (e.g., a business entity, organization, etc.), a group of entities (e.g., affiliated companies), and/or another type of entity that offers and/or coordinates the provision of one or more vehicle services to one or more users. For example, a service entity can offer vehicle service(s) to users via one or more software applications (e.g., that are downloaded onto a user computing device), via a website, and/or via other types of interfaces that allow a user to request a vehicle service. As described herein, the vehicle services can include transportation services (e.g., by which a vehicle transports user(s) from one location to another), delivery services (e.g., by which a vehicle transports/delivers item(s) to a requested destination location), courier services (e.g., by which a vehicle retrieves item(s) from a requested origin location and transports/delivers the item to a requested destination location), and/or other types of services. The vehicle services can be wholly performed by the vehicle 105 (e.g., travelling from the user/item origin to the ultimate destination, etc.) or performed by one or more vehicles and/or modes of transportation (e.g., transferring the user/item at intermediate transfer points, etc.).

An operations computing system 190A of the service entity 185 can help to coordinate the performance of vehicle services by autonomous vehicles. The operations computing system 190A can include and/or implement one or more service platforms of the service entity. The operations computing system 190A can include one or more computing devices. The computing device(s) can include various components for performing various operations and functions. For instance, the computing device(s) can include one or more processors and one or more tangible, non-transitory, computer readable media (e.g., memory devices, etc.). The one or more tangible, non-transitory, computer readable media can store instructions that when executed by the one or more processors cause the operations computing system 190A (e.g., it's one or more processors, etc.) to perform operations and functions, such as those described herein matching users and vehicles/vehicle fleets, deploying vehicles, facilitating the provision of vehicle services via autonomous vehicles, etc.

A user 125 can request a vehicle service from a service entity 185. For example, the user 125 can provide user input to a user device 130 to request a vehicle service (e.g., via a user interface associated with a mobile software application of the service entity 185 running on the user device 130). The user device 130 can communicate data indicative of a vehicle service request 195 to the operations computing system 190A associated with the service entity 185 (and/or another associated computing system that can then communicate data to the operations computing system 190A). The vehicle service request 195 can be associated with a user. The associated user can be the one that submits the vehicle service request (e.g., via an application on the user device 130). In some implementations, the user may not be the user that submits the vehicle service request. The vehicle service request can be indicative of the user. For example, the vehicle service request can include an identifier associated with the user and/or the user's profile/account with the service entity 185. The vehicle service request 195 can be generated in a manner that avoids the use of personally identifiable information and/or allows the user to control the types of information included in the vehicle service request 195. The vehicle service request 195 can also be generated, communicated, stored, etc. in a secure manner to protect information.

The vehicle service request 195 can indicate various types of information. For example, the vehicle service request 195 can indicate the type of vehicle service that is desired (e.g., a transportation service, a delivery service, a courier service, etc.), one or more locations (e.g., an origin location, a destination location, etc.), timing constraints (e.g., pick-up time, drop-off time, deadlines, etc.), and/or geographic constraints (e.g., to stay within a certain area, etc.). The service request 195 can indicate a type/size/class of vehicle such as, for example, a sedan, an SUV, luxury vehicle, standard vehicle, etc. The service request 195 can indicate a product of the service entity 185. For example, the service request 195 can indicate that the user is requesting a transportation pool product by which the user would potentially share the vehicle (and costs) with other users/items. In some implementations, the service request 195 can explicitly request for the vehicle service to be provided by an autonomous vehicle or a human-driven vehicle. In some implementations, the service request 195 can indicate a number of users that will be riding in the vehicle/utilizing the vehicle service. In some implementations, the service request 195 can indicate preferences/special accommodations of an associated user (e.g., music preferences, climate preferences, wheelchair accessibility, etc.) and/or other information.

The operations computing system 190A of the service entity 185 can process the data indicative of the vehicle service request 195 and generate a vehicle service assignment that is associated with the vehicle service request. The operations computing system can identify one or more vehicles that may be able to perform the requested vehicle services to the user 195. The operations computing system 190A can identify which modes of transportation are available to a user for the requested vehicle service (e.g., light electric vehicles, human-drive vehicles, autonomous vehicles, aerial vehicle, etc.) and/or the number of transportation modes/legs of a potential itinerary of the user for completing the vehicle service (e.g., single or plurality of modes, single or plurality of legs, etc.). For example, the operations computing system 190A can determined which autonomous vehicle(s) are online with the service entity 185 (e.g., available for a vehicle service assignment, addressing a vehicle service assignment, etc.) to help identify which autonomous vehicle(s) would be able to provide the vehicle service.

The operations computing system 190A and/or the vehicle computing system 110 can communicate with one or more other computing systems 190B that are remote from the vehicle 105. This can include, for example, computing systems associated with government functions (e.g., emergency services, regulatory bodies, etc.), computing systems associated with vehicle providers other than the service entity, computing systems of other vehicles (e.g., other autonomous vehicles, aerial vehicles, etc.). Communication with the other computing systems 190B can occur via the network(s) 120.

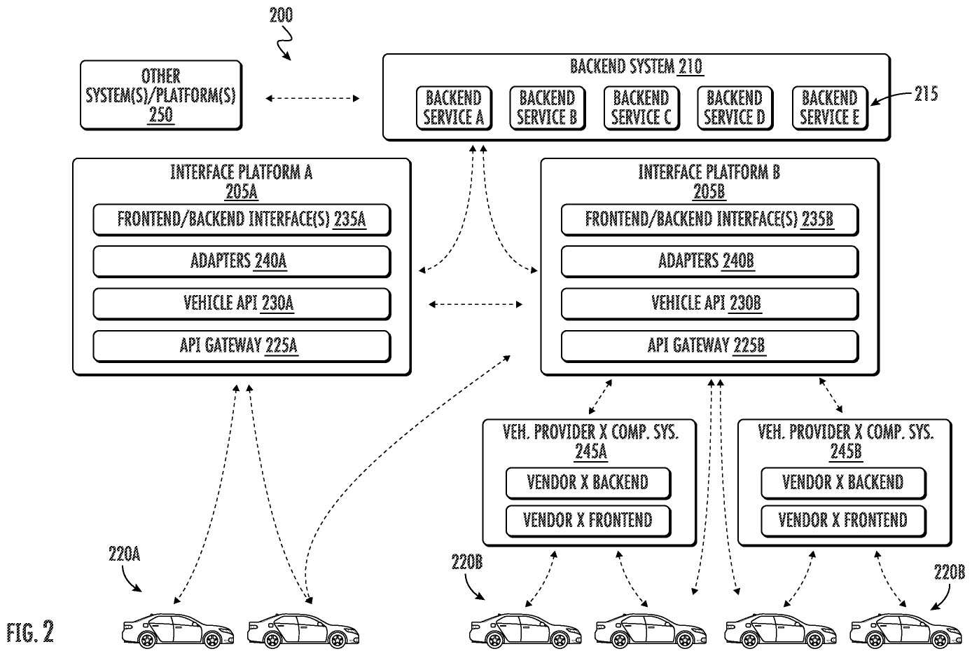

FIG. 2 depicts an example service infrastructure 200 according to example embodiments of the present disclosure. The service infrastructure 200 can include one or more systems, interfaces, and/or other components that can be included in an operations computing system of the service entity for coordinating vehicle services and managing/supporting the autonomous vehicle associated therewith. The service infrastructure 200 can represent, for example, the architecture of a service platform of the operations computing system for coordinating and providing one or more vehicle services (e.g., via autonomous vehicle(s), etc.).

The service infrastructure 200 of an operations computing system can include a first application programming interface platform 205A, a second application programming interface application platform 205B, and/or a backend system 210 with one or a plurality of backend services 215. These components can allow the service infrastructure 200 (e.g., the operations computing system) to communicate with one or more autonomous vehicles and/or one or more other systems.

The first application programming interface platform 205A can facilitate communication with one or more autonomous vehicles of the service entity. For example, as described herein, the service entity may own, lease, etc. a fleet of autonomous vehicles 220A that can be managed by the service entity (e.g., its backend services) to provide one or more vehicle services. The autonomous vehicle(s) 220A can be utilized by the service entity to provide the vehicle service(s) and can be included in the fleet of the service entity. Such autonomous vehicle(s) may be referred to as “service entity autonomous vehicles” or “first party autonomous vehicles.”

The first application programming interface platform 205A can include a number of components to help facilitate the support, coordination, and management of the first party autonomous vehicles 220A associated with the service entity. The first application programming interface platform 205A (e.g., a private platform, etc.) can provide access to one or more backend services 215 that are available to the first party autonomous vehicles 220A. To help do so, the first application programming interface platform 205A can include a first API gateway 225A. The first API gateway 225A can function as a proxy for application programming interface (API) calls and can help to return an associated response. The first API gateway 225A can help provide other support functions for the service infrastructure 200 such as, for example, authentication functions, etc.

The first application programming interface platform 205A can include one or more APIs such as, for example, a first vehicle API 230A. The vehicle API 230A can include a library and/or parameters for facilitating communications between the first party autonomous vehicles 225A and the backend service(s) 215 of the backend system 210. For example, the first vehicle API 230A can be called by a first party autonomous vehicle 220A and/or another system (e.g., system(s)/platform(s) 250) to help communicate data, messages, etc. to and/or from an autonomous vehicle and/or another system (e.g., system(s)/platform(s) 250). The first vehicle API 230A can provide for communicating such information in a secure, bidirectional manner that allows for expanded processing of data offboard a vehicle, analyzing such data in real time, and/or the like.

The first application programming interface platform 205A can include first frontend/backend interface(s) 235A. Each first frontend/backend interface 235A can be associated with a backend service 215 of the backend system 210. The first frontend/backend interface(s) 235A can serve as interface(s) for one client (e.g., an external client such as a first party autonomous vehicle 220A) to provide data to another client (e.g., a backend service 215). In this way, the frontend/backend interface(s) 235A can be external facing edge(s) of the first application programing interface platform 205A that are responsible for providing secure tunnel(s) for first party autonomous vehicles 220A (and/or other system(s)/platform(s) 250) to communicate with the backend system 215 (and vice versa) so that a particular backend service can be accessed by a particular first party autonomous vehicle 220A (and/or other system(s)/platform(s) 250).

In some implementations, the first application programing interface platform 205A can include one or more first adapters 240A, for example, to provide compatibility between one or more first frontend/backend interfaces 235A and one or more of the API(s) associated with the first application programming interface platform 205A (e.g., vehicle API 230A). The first adapter(s) 240A can provide upstream and/or downstream separation between particular infrastructure components, provide or assist with data curation, flow normalization and/or consolidation, etc.

The second application programming interface platform 205B (e.g., a public platform, etc.) can facilitate communication with one or more autonomous vehicles of a third-party vehicle provider. As described herein, a third-party vehicle provider can be an entity that makes one or more of its autonomous vehicles available to the service entity for the provision of vehicle services. This can include, for example, an individual, an original equipment manufacturer (OEM), a third party vendor, or another entity that places its autonomous vehicle(s) online with the service platform of the service entity such that the autonomous vehicle(s) can provide vehicle services of the service entity. These autonomous vehicles may be referred to as “third party autonomous vehicles” and are shown in FIG. 2 as third-party autonomous vehicles 220B. Even though such autonomous vehicles may not be included in the fleet of autonomous vehicles of the service entity, the service infrastructure 200 (e.g., of the service entity's service platform, etc.) can allow the third party autonomous vehicles 220B to provide vehicle services offered by the service entity, access the one or more backend services 215 of the backend system 210, etc.

The second application programming interface platform 205B can allow the service platform to communicate directly or indirectly with autonomous vehicle(s). In some implementations, a third-party autonomous vehicle 220B may call an API of, send data/message(s) to, receive data/message(s) from/directly through, etc. the second application programming interface platform 205B.

Additionally, or alternatively, another computing system can serve as an intermediary between the third-party autonomous vehicles 220B and the second application programming interface platform 205B (and the service platform associated therewith). For example, the service infrastructure 200 can be associated with and/or in communication with one or more third party vehicle provider computing systems 245, such as a vehicle provider X computing system and a vehicle provider Y computing system. Each third-party vehicle provider X, Y can have its own, separate third party autonomous fleet including respective third-party autonomous vehicles 220B. The third-party vehicle provider computing systems 245 can be distinct and remote from the service infrastructure 200 and provide for management of vehicles associated with that particular third-party vehicle provider. As shown in FIG. 2, a third-party vehicle provider computing system 245 can include its own backends and/or frontends for communicating with other systems (e.g., third party autonomous vehicle(s) 220B, operations computing system, etc.).

The third-party computing system 245 associated with a particular third-party autonomous vehicle fleet can serve as the communication intermediary for that fleet. For example, third party autonomous vehicles 220B associated with third party vehicle provider X can communicate with the third party vehicle provider X computing system 245A which can then communicate with the service infrastructure 200 (e.g., to access the available backend services 215) via the second application programming interface platform 205B. Data from the service infrastructure 200 (e.g., the backend services 215) can be communicated to the vehicle provider X computing system 245A (e.g., via the second application programming interface platform 235B) and then to the third-party autonomous vehicles 220B associated with third party vehicle provider X. In another example, third party autonomous vehicles 220B associated with third party vehicle provider Y can communicate with the third party vehicle provider Y computing system 245B which can then communicate with the service infrastructure 200 (e.g., to access the available backend services 215) via the second application programming interface platform 205B. Data from the service infrastructure 200 (e.g., the backend services 215) can be communicated to the third-party vehicle provider Y computing system 245B (e.g., via the second application programming interface platform 205B) and then to the third party autonomous vehicles 220B associated with third party vehicle provider Y.

The second application programming interface platform 205B can include a number of components to help facilitate the support, coordination, and management of the third-party autonomous vehicles 220B associated with the third-party vehicle providers. The second application programming interface platform 205B can provide access to one or more backend services 215 that are available to the third-party autonomous vehicles 220B. To help do so, the second application programming interface platform 205B can include a second API gateway 225B. The second API gateway 225B can function as a proxy for application programming interface (API) calls and can help to return an associated response. The second API gateway 225B can help provide other support functions for the service infrastructure 200 such as, for example, authentication functions, etc.

The second application programming interface platform 205B can include one or more APIs such as, for example, a second vehicle API 230B. The second vehicle API 230B can include a library and/or parameters for facilitating communications between the third party autonomous vehicles 220B and the backend service(s) 215 of the backend system 210. For example, the second vehicle API 230B can be called by a third-party autonomous vehicle 220B and/or another system (e.g., a third-party vehicle provider computing system 245, etc.) to help communicate data, messages, etc. to and/or from an autonomous vehicle. The second vehicle API 230B can provide for communicating such information in a secure, bidirectional manner.

The second application programming interface platform 205B can include second frontend/backend interface(s) 235B. Each of the second frontend/backend interface(s) 235B can be associated with a backend service 215 of the backend system 210. The second frontend/backend interface(s) 235B can serve as interface(s) for one client (e.g., an external client such as a third-party autonomous vehicle 220B, a third-party vehicle provider computing system 245) to provide data to another client (e.g., a backend service 215). In this way, the second frontend/backend interface(s) 235B can be external facing edge(s) of the second application programing interface platform 205B that are responsible for providing secure tunnel(s) for third party autonomous vehicles 220B (and/or other intermediary systems) to communicate with the backend system 210 (and vice versa) so that a particular backend service 215 can be utilized. In some implementations, the second application programing interface platform 205B can include one or more second adapters 240B, for example, to provide compatibility between one or more second frontend/backend interfaces 235B and one or more of the API(s) associated with the second application programming interface platform 205B (e.g., vehicle API 230B).

In some implementations, the first party autonomous vehicles 220A can utilize the second application programming interface platform 205B to access/communicate with the service platform/backend service(s) 215. This can allow for greater accessibility and/or back-up communication options for the first party autonomous vehicles 220A.

The backend system 210 can host, store, execute, etc. one or more backend services 215. The backend service(s) 215 can be implemented by system client(s), which can include hardware and/or software that is remote from the autonomous vehicles and that provide a particular service to an autonomous vehicle. The backend service(s) 215 can include a variety of services that help coordinate the provision of vehicle service(s) and support the autonomous vehicles and/or the third-party vehicle providers performing/providing those vehicle service(s).

For example, the backend service(s) 215 can include a matching service that is configured to match an autonomous vehicle and/or an autonomous vehicle fleet with a service request for vehicle services. Based on a match, the matching service can generate and communicate data indicative of a candidate vehicle service assignment (indicative of the requested vehicle service) for one or more autonomous vehicles. In some implementations (e.g., for first party autonomous vehicle(s) 220A), the candidate vehicle service assignment can include a command that a first party autonomous vehicle 220A is required to accept, unless it would be unable to safely or fully perform the vehicle service. In some implementations (e.g., for third party autonomous vehicle(s) 220B), the candidate vehicle service assignment can include a request or offer for one or more autonomous vehicles to provide the vehicle service. The candidate vehicle service assignment can be communicated to one or more third party vehicle provider computing systems 245 and/or one or more autonomous vehicle(s) 220B (e.g., via the interface platform B 205B) and/or one or more autonomous vehicle(s) 220A (e.g., via the interface platform A 205A). The candidate vehicle service assignment can be accepted or rejected. If accepted, an autonomous vehicle 220A, 220B can be associated (e.g., assigned to service, etc.) with the vehicle service assignment. The vehicle service assignment can include data indicative of the user, a route, an origin location for the vehicle service, a destination location for the vehicle service, service parameters (e.g., time restraints, user accommodations/preferences, etc.), and/or any other information associated with a vehicle service.

The backend service(s) 215 can include an itinerary service. The itinerary service can be configured to maintain, update, track, etc. a data structure indicative of one or more task(s) and/or candidate task(s) associated with (and/or potentially associated with) a particular autonomous vehicle, autonomous vehicle fleet, and/or vehicle provider. The tasks can include, for example, vehicle service assignments for providing vehicle services and/or tasks associated with an activity other than the performance of a vehicle service. For example, the tasks can include: a testing task (e.g., for testing and validating autonomy software, hardware, etc.); a data acquisition task (e.g., acquiring sensor data associated with certain travel ways, etc.); a re-positioning task (e.g., for moving an idle vehicle between vehicle service assignments, to high demand areas, etc.); a circling task (e.g., for travelling within the current geographic area in which a vehicle is located (e.g., circle the block or neighborhood), etc.); a maintenance task (e.g., for instructing travel to a service depot to receive maintenance, etc.); a re-fueling task; a vehicle assistance task (e.g., where a vehicle travels to assist another vehicle, etc.); a deactivation task (e.g. going offline such that a vehicle, fleet of vehicles, or vehicle providers no longer accept service request, etc.); a parking task; and/or other types of tasks. The itinerary service can maintain an itinerary for an autonomous vehicle, fleet, vehicle provider, etc. The itinerary can serve as a queue for the various tasks. In some implementations, the tasks can be associated with a priority or order for which they are deployed to an autonomous vehicle, fleet, vehicle provider, etc.

In some implementations, the vehicle service assignment can be associated with a multi-modal vehicle service. For example, the user may request and/or be provided a multi-modal user itinerary by which the user is to travel to the user's ultimate destination via two or more types of transportation modalities (e.g., ground based vehicle, aerial vehicle, public transit, etc.). As such, the origin location and/or destination location identified in the vehicle service assignment may include intermediate locations (e.g., transfer points) along the user's multi-modal itinerary.

The backend service(s) 215 can include a deployment service that communicates tasks for an autonomous vehicle to complete. For example, the deployment service can communicate data indicative of a vehicle service assignment and/or another task to an autonomous vehicle (or an intermediary system). The deployment service can communicate such data to an autonomous vehicle (or an intermediary system) based at least in part on the itinerary associated therewith. By way of example, the highest priority task and/or the task that is next in order can be deployed.

The backend services 215 can include a routing service. The routing service can be configured to provide an autonomous vehicle with a route for a vehicle service and/or another task. The route can be based at least in part on factors associated with the geographic area in which the autonomous vehicle is (or will be) travelling (e.g., roadways, weather, traffic, events, etc.). Additionally, or alternatively, the route can be based at least in part the autonomy capabilities of the autonomous vehicle (e.g., ability to complete an unprotected left-hand turn, U-turn, etc.). In some implementations, the routing service can be configured to assign, coordinate, monitor, adjust, etc. one or more designated pick-up and/or drop-off zones for the vehicle service(s). The routing service can be available to first party autonomous vehicles 220A. In addition, or alternatively, the routing service can be available to third party autonomous vehicles 220B if permitted/requested by an associated third-party vehicle provider.

The backend services 215 can include a rider experience service. The rider experience service can be configured to communicate data to a rider associated with the vehicle service. This can include, for example, upcoming vehicle actions, routes, drop-off zones, user adjustable vehicle conditions (e.g., music, temperature, etc.). Such information can be presented via a display device of an onboard tablet associated with an autonomous vehicle, a user device associated with the rider, etc. through a software application associated with the service entity.

The backend services 215 can include a remote assistance service. The remote assistance service can be configured to provide remote assistance to an autonomous vehicle and/or a user (e.g., a rider associated with the vehicle service, etc.). For example, a remote assistance operator can take over control of one or more vehicle operations and/or otherwise assist an autonomous vehicle during the one or more vehicle operations. By way of example, a remote assistance operator can remotely control the navigation of an autonomous vehicle to navigate the vehicle around/past an unexpected obstruction in a travel way (e.g., a fallen tree, etc.). In another example, the remote assistance operator can communicate with a user (e.g., via the onboard tablet, user's phone, etc.) in the event that the user is in need of help.

The backend services 215 can include a simulation/testing service. The simulation/testing service can help facilitate vehicle provider integration with the service platform. For example, simulation/testing service can provide testing environments for vehicle providers to simulate communications and/or the performance of vehicle services using the service infrastructure 200.

The backend services 215 can include one or more other services. This can include, for example, payment services, vehicle rating services, health and maintenance services, software update/deployment services, and/or other services.

In some implementations, one or more backend services 215 that are available to the first party autonomous vehicles 220A (e.g., via the first application programming interface platform 205A) may not be available to the third party autonomous vehicles 220B (e.g., via the second application programming interface platform 205B), and vice versa. For example, a software update/deployment service for the first party autonomous vehicles 220A may not be accessible or suitable for a third-party autonomous vehicle 220B that utilizes the onboard autonomy software of a third-party vehicle provider (not the service entity). As such, a software update/deployment backend service may not be able to communicate with a third-party autonomous vehicle 220B and/or vice versa.

In some implementations, the service infrastructure 200 can include a test platform for validating and vetting end-to-end platform functionality, without use of a real vehicle on the ground. For example, the test platform can simulate trips with human drivers and/or support fully simulated trip assignment and/or trip workflow capabilities. For example, the test platform can simulate and monitor data traffic through the service infrastructure 200 to ensure proper functioning. In some implementations, the testing platform can access the simulation/testing backend to help facilitate a test or simulation.

In some implementations, the service infrastructure 200 can utilize a plurality of software development kits (SDKs) that help provide access to the first and second application programming interface platforms 205A, 205B. All (or a portion of) external communication with the platforms can be done via the SDKs. For example, the SDKs can include a first SDK (e.g., private SDK) and a second SDK (e.g., public SDK) and specific endpoints to facilitate communication with the first and second application programming interface platforms 205A, 205B, respectively. In some implementations, the first party autonomous vehicle(s) 220A (and/or a test platform) can use both the first and second SDKs, whereas the third-party autonomous vehicles 220B and/or the third-party vehicle provider computing systems 245 can use only the second SDK and associated endpoints. In some implementations, the SDKs can provide a single entry point, which can improve consistency across both the service provider fleet and the third-party entity fleet(s). As an example, a second SDK can provide secured access to the second application interface platform 205B and access to capabilities such as vehicle service assignments, routing, and/or the like. The first SDK can be accessed by the first party autonomous vehicles 205A and provide access to capabilities including those available only to the first party autonomous vehicles 205A.

In some implementations, the SDKs can include a command-line interface to provide an entry point into the SDK components and act as a gateway for SDK related work, integration, testing, and authentication. For example, the command-line tools can provide for bootstrapping, managing authentication, updating SDK version, testing, debugging, and/or the like. In some implementations, a command-line interface can require an authentication certificate before being able to bootstrap an SDK, download components, and/or access a service entity's services. For example, based on the authentication certificate, a command-line interface can determine which version of the SDK to which to provide access. In some implementations, SDKs can be implemented onboard a first- or third-party autonomous vehicle 220A, 220B and/or a third-party vehicle provider computing system 245.

In some implementations, the service infrastructure 200 can facilitate communication between the service platform and one or more other system(s)/platform(s) 250 associated with the service entity/operations computing system. By way of example, the service entity may have (e.g., the operations computing system may include, etc.) one or more other system(s)/platform(s) 250 that can help indicate what services/vehicles are available to a user or other system, coordinate the provision of vehicle services by human-driven vehicles, and/or are specifically associated with certain types of services (e.g., delivery services, aerial transport services, etc.). The other system(s)/platform(s) 250 may communicate with the service platform utilizing the service infrastructure 200 (e.g., interface platform 205A, etc.) to determine, for example, whether any autonomous vehicles would be available to the user for any potential vehicle services.

The autonomous vehicles 220A, 220B utilized by the service entity to provide vehicle services can be associated with a fleet of the service entity or a third party. A fleet can include one or a plurality of autonomous vehicles 220A, 220B. The plurality of autonomous vehicles 220A, 220B can be associated with a single entity/party. For example, the service entity may own, lease, etc. a fleet of autonomous vehicles 220A that can be managed by the service entity (e.g., its backend system clients) to provide one or more vehicle services. An autonomous vehicle 220A utilized to provide the vehicle service(s) can be included in this fleet of the service entity. Such an autonomous vehicle 220A may be referred to as “service entity autonomous vehicles” or “first party autonomous vehicles” and can be included in a “first party autonomous vehicle fleet.” In some implementations, an autonomous vehicle 220B can be associated with a third-party vehicle provider such as, for example, an individual, an original equipment manufacturer (OEM), a third-party vendor, or another entity. These autonomous vehicles 220B may be referred to as “third party autonomous vehicles” and can be included in a “third party autonomous vehicle fleet.” Even though such an autonomous vehicle 220B may not be included in the fleet of autonomous vehicles of the service entity, the service platform can allow the autonomous vehicle(s) 220B associated with a third party to still be utilized to provide the vehicle services offered by the service entity, access the service entity's back-ends systems 210, etc.

A service entity may have varying levels of control over the vehicle(s) 220A, 220B that perform its vehicle services. In some implementations, a vehicle 220A can be included in the service entity's dedicated supply of vehicles. The dedicated supply can include vehicles 220A that are owned, leased, or otherwise exclusively available to the service entity (e.g., for the provision of its vehicle service(s), other tasks, etc.) for at least some period of time. This can include, for example, the first party autonomous vehicles 220A. Additionally, or alternatively, this can include a third party autonomous vehicle 220B that is associated with a third party vehicle provider, but that is online only with that service entity (e.g., available to accept vehicle service assignments for only that service entity, etc.) for a certain time period (e.g., a few hours, a day, week, etc.).

In some implementations, a vehicle 220B can be included in the service entity's non-dedicated supply of vehicles. his can include vehicles that are not exclusively available to the service entity. For example, a third party autonomous vehicle 220B that is currently online with two different service entities (e.g., concurrently online with a first service entity and a second service entity, etc.) so that the autonomous vehicle 220B may accept vehicle service assignment(s) from either service entity, may be considered to be part of a non-dedicated supply of vehicles. In some implementations, whether a vehicle 220B is considered to be part of the dedicated supply or the non-dedicated supply can be based, for example, on an agreement between the service entity and a third-party vehicle provider associated with that vehicle.

The operations computing system can determine which autonomous vehicles are available for a vehicle service/vehicle service request. In some implementations, the available autonomous vehicles 220A, 220B can include those that are currently online with the service entity (e.g., actively engaged, logged in, etc. to a service platform/service entity infrastructure 200, etc.) and are not currently engaged in performance of a vehicle service, performance of a maintenance operation, and/or another task. In some implementations, the operations computing system can determine the availability of an autonomous vehicle 220A, 220B based at least in part on data indicating that the autonomous vehicle is online, ready to provide a vehicle service, etc. This can include, for example, data communicated directly from an autonomous vehicle and/or from another computing system 245A, 245B (e.g., a third-party computing system, etc.). In some implementations, the operations computing system can monitor an autonomous vehicle (e.g., its progress along a route, when it comes online, etc.) to help determine whether the autonomous vehicle may be available to service a vehicle service request.

As described herein, each autonomous vehicle 220A, 220B that is online with the service entity can be associated with an itinerary. The itinerary can be a data structure (e.g., a list, table, tree, queue, etc.) that is stored and accessible via a backend service of the service infrastructure 200 (e.g., an itinerary service, etc.). The itinerary can include a sequence of tasks for the autonomous vehicle. In some implementations, the operations computing system can determine that a vehicle is (or is not) available to provide a vehicle service based at least in part on an associated itinerary.

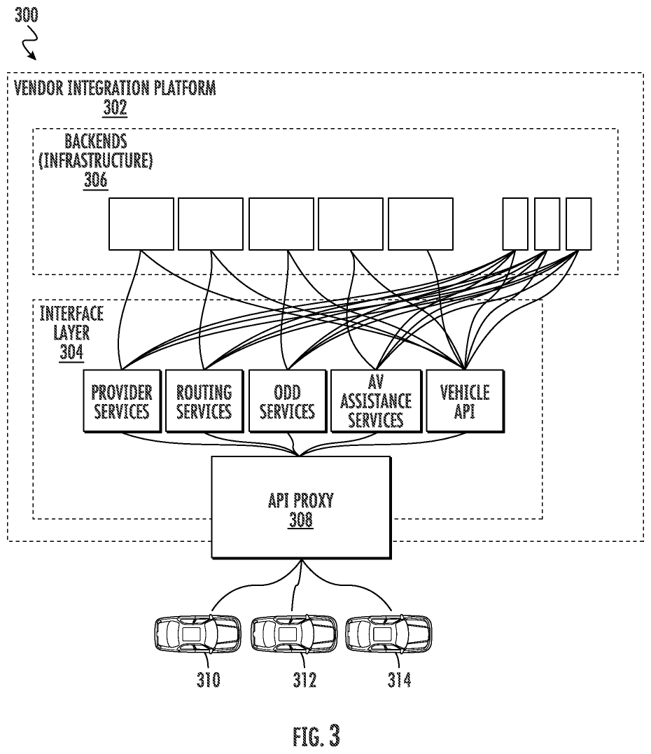

FIG. 3 depicts an example of an entity integration platform 300 according to example embodiments of the present disclosure. As illustrated in FIG. 3, an entity integration platform 300 can include a vendor integration platform (e.g., public platform) 302 in communication with one or more vehicles, such as autonomous vehicles 310, 312, and 314. As described in regard to FIG. 2, the public platform 302 can provide for communication between a plurality of backend services 306 and one or more autonomous vehicles (e.g., 310, 312, and/or 314) via a plurality of interfaces 304. As such, public platform 302 of FIG. 3 can in some embodiments correspond to public platform 202 of FIG. 2, while backend services 306 and/or interfaces 304 of FIG. 3 can in some embodiments correspond to backend interfaces 224 of FIG. 2 and corresponding applications, interfaces, and the like. In some implementations, the public platform 302 can include application programming interface (API) proxy 308 to act as a central gateway to the public platform 302 for communications to/from the autonomous vehicles. In some embodiments, an autonomous vehicle (e.g., 310, 312, and/or 314) can communicate with the API proxy 308 via an SDK associated with the autonomous vehicle, as described herein.

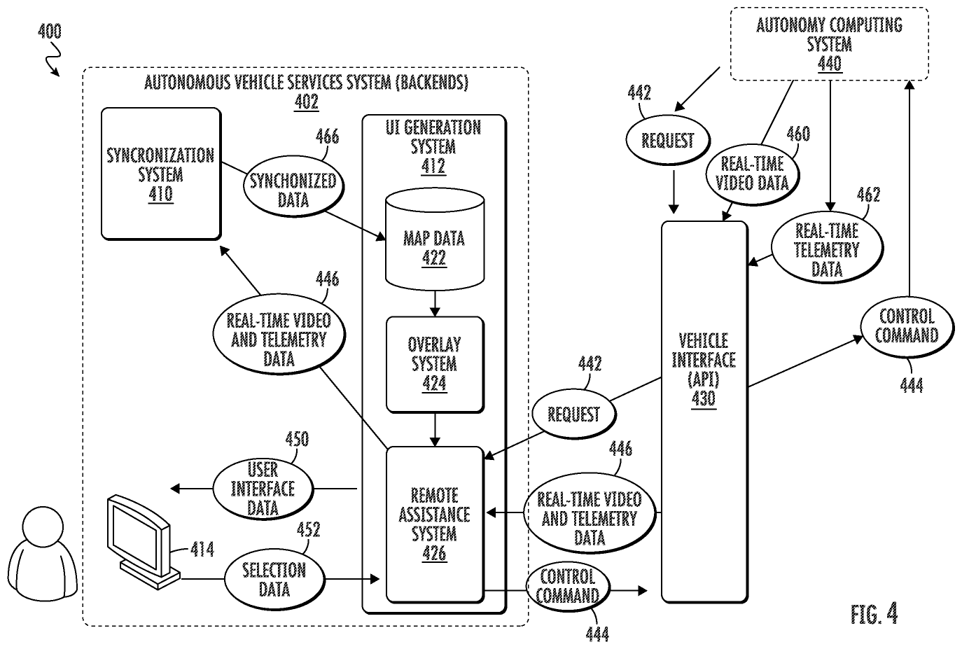

FIG. 4 depicts an example computing system 400 for providing an improved remote assistance user interface to remote assistance operators providing remote autonomous vehicle assistance to autonomous vehicles (e.g., autonomous vehicle 105 in FIG. 1) according to example embodiments of the present disclosure. The computer system 400 can include an autonomous vehicle service system 402, one or more vehicle interfaces 430 (e.g., API(s)), and one or more autonomy computing systems 440. The autonomous vehicle service system 402 can include a UI (User Interface) generation system 412, a synchronization system 410, and one or more operator computing systems 414.

One or more vehicle interfaces 430 (e.g., an API available to the autonomy computing system 440) of an operations computing system may receive a request 442 from an autonomous vehicle (e.g., autonomous vehicle 105 in FIG. 1) for remote autonomous assistance with one or more autonomy computing system 440 tasks at the autonomy computing system 440. The vehicle interface 430 can pass the request 442 and/or real-time video and telemetry data 446 to a remote assistance system 426 of the UI generation system 412.

In some examples, a request 442 for remote autonomous vehicle assistance may be received from a computing device separate from the autonomous vehicle. For example, a user of an autonomous vehicle service may send a request 442 for autonomous vehicle assistance using a client device such as a smartphone, tablet, etc. A client device may initiate a telephone call to connect the user with an operations computing system. In some examples, an operations computing system associated with the autonomy computing system 440 can match a telephone number or other identifier with a particular user or autonomous vehicle.

The UI generation system 412 can be configured to process requests 442 for remote assistance, employ a synchronization system 410 to synchronize real-time video data 460 and real-time telemetry data 462, generate a remote assistance user interface for display at an operator computing system 414, transmitting user interface data to the operator computing system 414 for display, and generate one or more control commands 444 for an autonomy computing system 440 of an autonomous vehicle in response to the requests 442.

The UI generation system 412 can include a remote assistance system 426. The remove assistance system 426 can receive the request 442 for remote assistance. In addition, the remote assistance system 426 can receive real-time video data and real-time telemetry data 446. The real-time video data can include data captured by one or more sensors (e.g., cameras) associated with the autonomy computing system 440. The real-time telemetry data can include data produced by the autonomy system associated with the autonomous vehicle (e.g., autonomous vehicle 105 in FIG. 1) and may include information describing the location and poses of objects in the environment of the autonomous vehicle (e.g., autonomous vehicle 105 in FIG. 1), prediction actions of one or more actors, intentions of the autonomous vehicle (e.g., autonomous vehicle 105 in FIG. 1), and so on. The remote assistance system 426 can transmit the real-time video data and the real-time telemetry data 426 to the synchronization system 410. The real-time video data and the real-time telemetry data can be received as a stream of data that continues to be received as the autonomy system 440 captures new video or updates its telemetry data. In this way, the remote assistance system 426 can have live, up-to-date data from the requesting autonomous vehicle (e.g., autonomous vehicle 105 in FIG. 1).

The real-time video data and real-time telemetry data 446 can include a plurality of frames, each frame associated with a particular time (e.g., having an included timestamp). The synchronization system 410 can, based on the time associated with each frame of the real-time video data, identify real-time telemetry data that is associated with the same time. For example, the synchronization system 410 can identify a frame of real-time telemetry data with a timestamp that matches the timestamp of a particular frame of real-time video data. Alternatively, the synchronization system 410 can determine the length of time between the timestamp associated with a particular frame of real-time video data and a plurality of real-time telemetry data frames. The synchronization system 410 can identify the real-time telemetry frame with the least length of time.

Thus, each frame of real-time video data 460 can have a matching frame of real-time telemetry frame. The matching real-time video frames and real-time telemetry frames can result in synchronized data 466 and be transmitted to the UI generation system 412.

The UI generation system 412 can use the synchronized data 466 to generate a remote assistance user interface for display at an operator computing system 414. To do so, the UI generation system 412 can access map data 422 stored in a database. As noted above, map data 422 can provide detailed information about the surrounding environment of an autonomous vehicle (e.g., autonomous vehicle 105 in FIG. 1). For example, the map data 422 can provide information regarding: the identity and location of different roadways, road segments, buildings, or other items or objects (e.g., lampposts, crosswalks and/or curb); the location and directions of traffic lanes (e.g., the location and direction of a parking lane, a turning lane, a bicycle lane, or other lanes within a particular roadway or other travel way and/or one or more boundary markings associated therewith); traffic control data (e.g., the location and instructions of signage, traffic lights, or other traffic control devices); and/or any other map data that provides information that can assist the remote operator in processing and analyzing a situation associated with the remote assistance request.

The UI generation system 412 can generate an interface that includes an area in which real-time video can be displayed and an area in which map data can be displayed. An overlay system 424 can generate a graphical overlay for the real-time video data and/or the map data. Generating the graphical overlay can include determining a coordinate system for the real-time video data displayed in the remote assistance graphical user interface. In some examples, the overlay system 424 can use information about the position and angle of the camera providing the real-time video data (e.g., located at the autonomous vehicle (e.g., autonomous vehicle 105 in FIG. 1)), the pose of the autonomous vehicle (e.g., autonomous vehicle 105 in FIG. 1), and information about the camera itself (e.g., field of view, etc.) to determine, what portions of the area around the autonomous vehicle (e.g., autonomous vehicle 105 in FIG. 1) are visible in the real-time video data displayed in the remote assistance user interface. The overlay system 424 can map specific areas around the autonomous vehicle (e.g., autonomous vehicle 105 in FIG. 1) to particular pixels or groups of pixels in the real-time video data display area. This mapping can be used to determine the expected location in the displayed real-time video data for objects, intentions, and measurements in the telemetry data,

In some examples, the positions of objects, intentions, and measurements in the telemetry data can be described with respect to the coordinate system associated with the autonomous vehicle (e.g., autonomous vehicle 105 in FIG. 1). Using the mapping between the geographic area around the autonomous vehicle to specific portions of the real-time video display area, the overlay 424 can covert locations from the coordinate system associated with the autonomous vehicle (e.g., autonomous vehicle 105 in FIG. 1) to the corresponding location in the real-time video display area.

Thus, when generating a graphical element for a particular object or location in the telemetry data, the overlay system 424 can first transform its location into the base coordinate system of the real-time video display area and then generate an appropriately sized and position graphical element. Once all necessary elements from the telemetry data have been generated as graphic elements, the remote assistance computing system can display the graphic elements as a graphic overlay to the real-time video data. Graphic elements can represent the size, location, and position of an object, bounding shape, predicted object trajectory, planned AV trajectory, etc.

Similarly, the graphic overlay can include one or more graphical elements associated with the intentions of the autonomous vehicle (e.g., autonomous vehicle 105 in FIG. 1). Thus, a proposed path can be displayed over the real-time video data indicating a potential further path for the autonomous vehicle (e.g., autonomous vehicle 105 in FIG. 1). In another example, if the autonomous vehicle (e.g., autonomous vehicle 105 in FIG. 1) intends to stop at a particular point, the graphical overlay can include graphical elements representing a stopping point.

Once the overlay system 424 generates a graphical overlay, the UI generation system 412 can compose the user interface data associated with displaying the remote assistance user interface. The UI generation system 412 can generate one or more possible remote assistance actions. The remote assistance actions can be displayed in the generated remote assistance user interface. In some examples, the overlay system 424 can generate one or more graphical interface elements for each remote assistance action that represent the result of selecting a particular remote assistance action. These graphical user elements can be selectively displayed based on the input of the remote assistance operator. For example, if the remote assistance operator hovers a cursor over a particular remote assistance option, the associated graphical interface elements can be displayed in the overlay and be removed when the cursor is no longer hovering over the option.

The remote assistance system 426 can transmit user interface data 450 to an operator computing system 414. The operator computing system can display the remote assistance user interface for the remote operator to view. For example, the remote assistance user interface may include an interface area for displaying real-time video data, map data, a graphical overlay, and information about the requesting autonomous vehicle (e.g., autonomous vehicle 105 in FIG. 1) or the current situations. The user interface can include one or more remote assistance options, each of which includes one or more interface elements associated with a remote assistance action. In some examples, a specific area of the remote assistance user interface can be dedicated to displaying one or more remote assistance options. For example, a user interface can include a sidebar area into which user interface elements associated with specific remote assistance actions are displayed.

An operator may view the user interface data 450 in order to determine a selection action using an operator computing system (414). As a particular example, an autonomous vehicle may issue a request 442 for assistance navigating around an object. An operator may view real-time video data of the object and the surrounding environment and review the one or more remote assistance actions presented in the remote assistance user interface. The operator can provide an input to an operator computing system 414 indicating selection of one or more remote assistance actions displayed in remote assistance user interface (e.g., designating a particular route for the autonomous vehicle (e.g., autonomous vehicle 105 in FIG. 1) to take). The operator computing system 414 can generate a route based on the remote operator input. The selected route may comprise the selected action that is provided from the operator computing system 414 to the remote assistance system 426 in the selection data 452. The remote assistance system 426 can generate one or more control commands 444 (herein also referred to as control messages) to the autonomy computing system 440 of the autonomous vehicle including data indicative of the selected route generated by the remote assistance system 426 from the remote operator input.

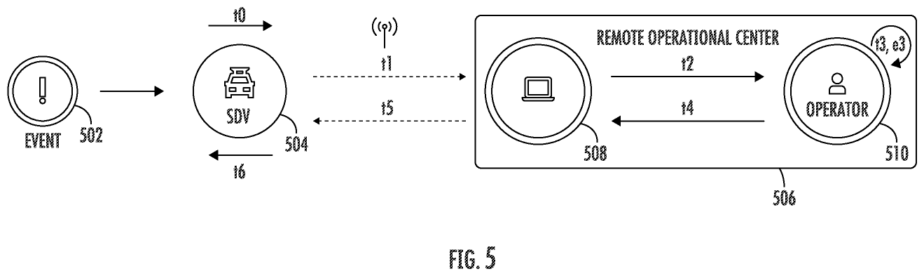

FIG. 5 depicts an example block diagram of a system for providing a remote assistance user interface based on received video and telemetry data according to example aspects of the present disclosure. In this example, an event 502 can occur and be sensed by the autonomous vehicle 504 (e.g., via one or more sensors included in the vehicle). For example, the event can be an object that is detected fallen across the planned path of the autonomous vehicle 504.

In some examples, an autonomy system on board the autonomous vehicle 504 can analyze how to respond to the event 502. In some examples, this analysis can include generation of telemetry data by the autonomous vehicle 504. If the autonomous vehicle 504 determines that it is unable to choose a response with sufficiency confidence, the autonomous vehicle 504 can transmit a remote assistance request to a remote operational center 506. In some examples, the autonomous vehicle 504 can begin transmitting a stream of real-time video data and a stream of real-time telemetry data with the request for remote assistance. In other examples, the autonomous vehicle 504 can wait until prompted to begin transmitting a stream of real-time video data and a stream of telemetry data. In addition, the autonomous vehicle 504 can transmit one or more potential actions that are currently being evaluated for suitability.

In some examples, the remote operation center 506 can generate a remote assistance user interface for a remote operator computing system 508. The remote assistance user interface can include real-time video data and a graphical overlay generated based on real-time telemetry data. The remote assistance operator 510 can, based on the information displayed in the remote assistance user interface, select a remote assistance action. The remote operational center 506 can transmit the selected remote assistance action to the autonomous vehicle 504.

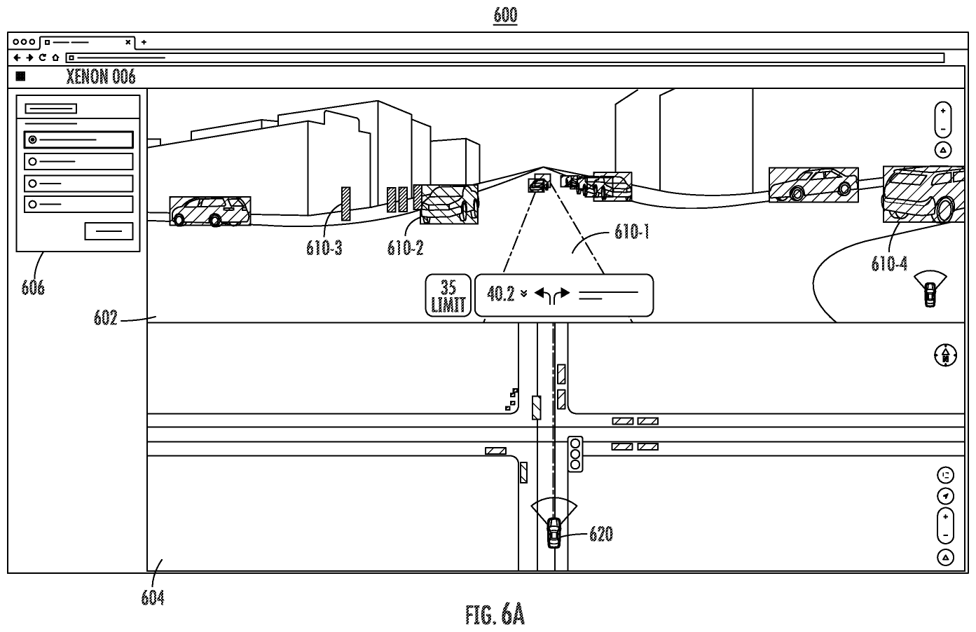

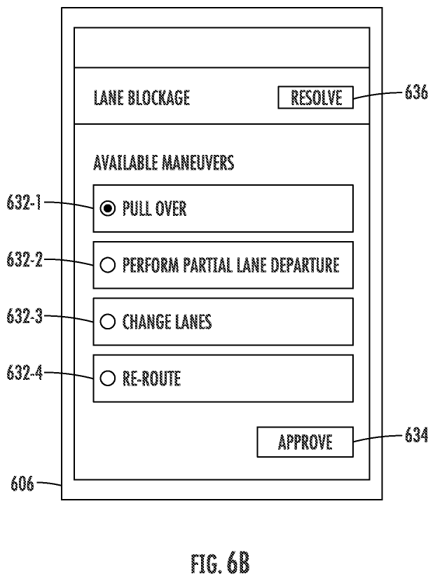

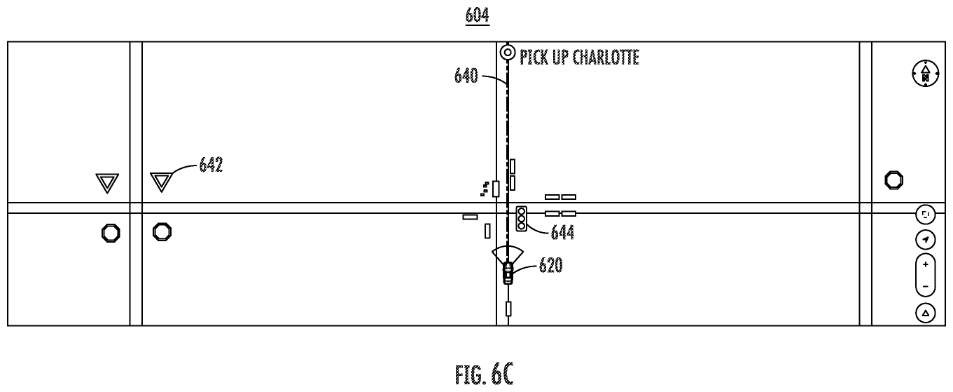

FIG. 6A depicts an example user interface for providing remote assistance to an autonomous vehicle according to example aspects of the present disclosure. The user interface 600 can include a real-time video display area 602, a map display area 604, and a remote action selection area 606.

The real-time video display area 602 can be a live stream of camera data from the requesting autonomous vehicle (e.g., autonomous vehicle 105 in FIG. 1). The real-time video display area 602 can include information about the position of the autonomous vehicle (e.g., autonomous vehicle 105 in FIG. 1) it's current situation and velocity and the current speed limit. In addition, a graphical overlay can represent telemetry data from the autonomous vehicle (e.g., autonomous vehicle 105 in FIG. 1) and is displayed at one or more graphical elements displayed over the real-time video data. In this example, the graphical overlay can include a graphical element 610-1 that represents the autonomous vehicle (e.g., autonomous vehicle 105 in FIG. 1) intends to follow. One or more pedestrians can be highlighted by a pedestrian bounding box graphical element 610-3. Similarly, one or more parked cars can be denoted by a parked car bounding box 610-4. In addition, one or more objects or conditions associated with the current situation can be highlighted with an issue bounding box 610-2.

The map display area 604 can include a representation of the location nearby the autonomous vehicle (e.g., autonomous vehicle 105 in FIG. 1) including streets, lane lines, signs, and so on. The map display area 604 can include a representation of the position of the autonomous vehicle 620 and one or more graphical overlay elements that represent, on the map, the location of objects that have associated graphical overlay elements in the real-time video display area 602.

The remote action selection area 606 can include one or more potential remote assistance options. These represent potential instructions the remote operator can select and cause to be implemented by the autonomous vehicle (e.g., autonomous vehicle 105 in FIG. 1). For example, the remote operator can select (e.g., by clicking) a particular option and, in response, the remote assistance computing system can transmit instructions to the autonomous vehicle (e.g., autonomous vehicle 105 in FIG. 1).

FIG. 6B depicts an example user interface for providing remote assistance to an autonomous vehicle according to example aspects of the present disclosure. The remote action selection area 606 can include a plurality of potential remote assistance options (632-1, 632-2, 632-3, and 632-4). The remote action selection area 606 can include an “approve” user interface element 634 that allows the remote assistance operator to choose a particular option. The remote action selection area 606 can also include a “resolve” button 636, allowing the remote assistance operator to make an issue as resolved. As noted above, this remote action selection area 606 can be displayed in the remote assistance user interface 600.

FIG. 6C depicts an example user interface for providing remote assistance to an autonomous vehicle according to example aspects of the present disclosure. The map area 604 can include a representation of the autonomous vehicle 620. The map area 604 can include features of the area, including one or more signs 642 and a traffic light 644. The map area 604 can include a planned path 640 of the autonomous vehicle 620. The map area 604 can include one or more graphical overlay elements that represent objects represented in the telemetry data.

As noted above, the map area 604 can be displayed in the remote assistance user interface 600, concurrently with the real-time video display area 602 and the remote selection 606. The map area 604 can be updated to correspond to the real-time video display area 602, the location of the autonomous vehicle (e.g., autonomous vehicle 105 in FIG. 1), and real-time telemetry data.

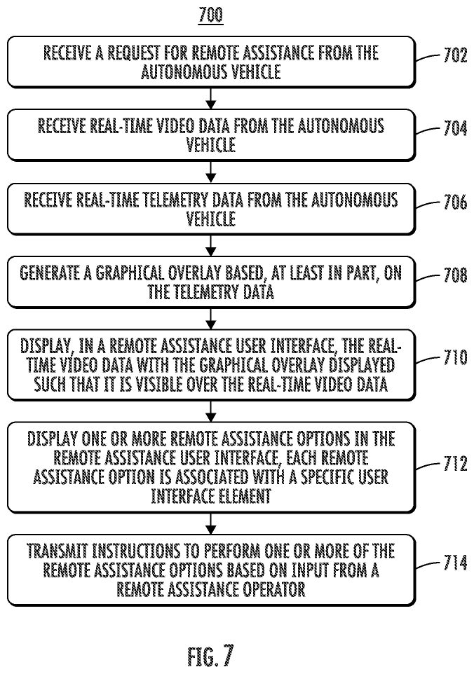

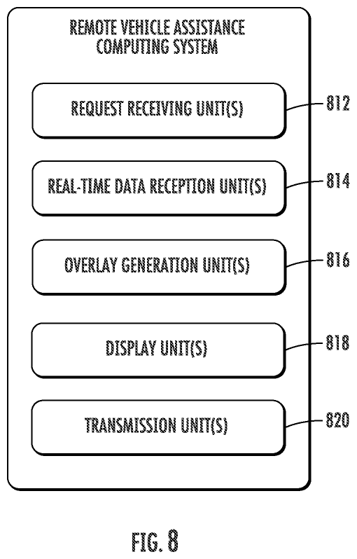

FIG. 7 depicts a flowchart illustrating an example method 700 for providing remote assistance according to example embodiments of the present disclosure. One or more portions of method can be implemented by one or more computing devices such as, for example, a computing device associated with the remote assistance system (e.g., remote assistance system 426 in FIG. 4). One or more portions of the method 700 described herein can be implemented as an algorithm on the hardware components of the devices described herein (e.g., as in FIGS. 1, 43, 8, and 9) to, for example, provide an improved user interface for a remote assistance operator. Although FIG. 7 depicts steps performed in a particular order for purposes of illustration and discussion, method 700 of FIG. 7 is not limited to the particularly illustrated order or arrangement. The various steps of the methods disclosed herein can be omitted, rearranged, combined, and/or adapted in various ways without deviating from the scope of the present disclosure. The various steps are described, for example, as being performed by a computing system onboard an autonomous vehicle for example purposes. One or more portions could also, or alternatively, be performed by a system offboard/remote from the autonomous vehicle.

A service provider can provide a remote assistance computing system (e.g., remote assistance system 426 in FIG. 4) to respond to remote assistance requests from autonomous vehicles or passengers in an autonomous vehicle. The remote assistance computing system (e.g., remote assistance system 426 in FIG. 4) can, at 702, receive a request for remote assistance from the autonomous vehicle (e.g., autonomous vehicle 105 in FIG. 1). The remote assistance request includes information describing the current situation of the autonomous vehicle including the location of the autonomous vehicle and the information describing why the request for remote assistance was sent.

The remote assistance computing system (e.g., remote assistance system 426 in FIG. 4) can receive, at 702, real-time video data from the autonomous vehicle (e.g., autonomous vehicle 105 in FIG. 1). In some examples, the real-time video data, when displayed in the remote assistance user interface, can at least partially replicate the view a driver of the autonomous vehicle (e.g., autonomous vehicle 105 in FIG. 1) would have. The real-time video frame comprises a plurality of video frames, each video frame in the plurality of video frames includes timestamp data. The real-time video data can be a live or near-live display of what is currently happening near or around the requesting autonomous vehicle (e.g., autonomous vehicle 105 in FIG. 1).

The remote assistance computing system (e.g., remote assistance system 426 in FIG. 4) can, at 706, receive real-time telemetry data from the autonomous vehicle (e.g., autonomous vehicle 105 in FIG. 1). This can include a direct or indirect receipt of such data. Telemetry data can include data produced by the autonomy system of the autonomous vehicle (e.g., autonomous vehicle 105 in FIG. 1) based on processing sensor data to detect its environment, predict the motion of other actors, and plan the motion of the autonomous vehicle (e.g., autonomous vehicle 105 in FIG. 1) going forward. In some examples, the telemetry data includes one or more intended actions of the autonomous vehicle (e.g., autonomous vehicle 105 in FIG. 1). In some examples, the telemetry data includes one or more of: a classification for one or more objects in the real-time video data and a predicted measurement of at least one parameter associated with the real-time video data (e.g., information about the speed of the autonomous vehicle, a distance to a planned stop, or a distance afforded for a lane change).

The remote assistance computing system (e.g., remote assistance system 426 in FIG. 4) can, at 708, generate a graphical overlay based, at least in part, on the telemetry data. The graphical overlay can include one or more graphic elements that can be superimposed over the real-time video data in the remote assistance user interface.

The remote assistance computing system (e.g., remote assistance system 426 in FIG. 4) can access map data of the geological position associated with the autonomous vehicle (e.g., autonomous vehicle 105 in FIG. 1). The remote assistance computing system (e.g., remote assistance system 426 in FIG. 4) can present a remote assistance interface, the remote assistance interface including a real-time video display area and a map view area, the real-time display area displaying the real-time video data and the map view area displaying the map data associated with geographic location the autonomous vehicle (e.g., autonomous vehicle 105 in FIG. 1). The remote assistance computing system can, at 710, display, in a remote assistance user interface, the graphical overlay displayed such that it is visible over the map data.

For example, the graphical overlay can denote the locations of predetermined parking and/or/stopping locations. This information can also include whether these locations are currently blocked or available as pick-up/drop-off zones (PDZs). In some examples, the remote assistance operator can select or otherwise interact with an element shown over the map data as a graphical overlay. In response, the remote assistance computing system (e.g., remote assistance system 426 in FIG. 4) can update the map view to show a rendering of a potential route/motion plan to the selected element. Thus, the map view can allow the remote assistance operator more information to determine the best course of action. In some examples, the remote assistance operator can select an element from the graphic overlay displayed over the map view and the remote assistance computing system (e.g., remote assistance system 426 in FIG. 4) can update the graphical overlay over the real-time video data to show a path or other selected element to the remote assistance operator from the perspective of a driver.

The remote assistance computing system (e.g., remote assistance system 426 in FIG. 4) can synchronize the real-time video data with the real-time telemetry data. To synchronize the real-time video data and the real-time telemetry data, the remote assistance computing system (e.g., remote assistance system 426 in FIG. 4) can, for a respective video frame in the plurality of video frames, identify a telemetry frame such that the timestamp data associated with the telemetry frame is within a predetermined time of the timestamp data associated with the respective video frame.

Using the identified telemetry frame, the remote assistance computing system (e.g., remote assistance system 426 in FIG. 4) can generate the graphical overlay to be displayed while the respective video frame is being displayed. In some examples, the graphical overlay includes a graphical representation of one or more intended actions of the autonomous vehicle (e.g., autonomous vehicle 105 in FIG. 1). For example, a planned path can be displayed in the graphical overlap as a highlighted trajectory. In some examples, the graphical overlay includes a graphical representation of one or more of: the classification for one or more objects in the real-time video data and the predicted measurement of at least one parameter associated with the real-time video data.

In some examples, the graphical overlay can include an indication of one or more potential issues that are associated with the remote assistance request. For example, if a particular obstacle is a reason the request was sent, the remote assistance computing system (e.g., remote assistance system 426 in FIG. 4) can generate a graphical element that highlights the specific obstacle in the remote assistance user interface. The remote assistance computing system (e.g., remote assistance system 426 in FIG. 4) can, at 712, display, in a remote assistance user interface, the real-time video data with the graphical overlay displayed such that it is visible over the real-time video data.

The remote assistance computing system (e.g., remote assistance system 426 in FIG. 4) can display one or more remote assistance options in the remote assistance user interface, each remote assistance option is associated with a specific user interface element. The remote assistance computing system (e.g., remote assistance system 426 in FIG. 4) can receive input from a remote assistance operator on a user interface element. For example, a remote assistance operator can click on a particular user interface element to select its associated remote assistance option. Other interactions, such as left-clicking an element or hovering a cursor over an element can cause the remote assistance computing system to display additional information or generate a graphical representation of the results of selecting a particular option (e.g., the specific route the autonomous vehicle would take).

In response to receiving input from the remote assistance operator with respect to the user interface element, the remote assistance computing system (e.g., remote assistance system 426 in FIG. 4) can remove one or more graphical interface elements from the graphical overlay. For example, the graphic elements associated with static objects are not needed by the remote assistance operator to choose a particular option, the remote assistance interface can include an element that allows a particular type of graphic element to be hidden or removed.

In some examples, each remote assistance option can have associated telemetry data included in the live-streamed telemetry data. For example, the telemetry data can include information describing how the autonomous vehicle will react to one or more of the remote assistance options. Thus, if the remote assistance computing system (e.g., remote assistance system 426 in FIG. 4) can receive user interaction from the remote assistance operator with a specific user interface element associated with a particular remote assistance option it can display additional graphical interface elements in the graphical overlay, the additional graphical interface elements being associated with the specific user interface element. Thus, the graphic overlay can be updated to display a probable stopping point if the remote assistance operator selects an option that directs the autonomous vehicle (e.g., autonomous vehicle 105 in FIG. 1) to pull over as soon as possible.

The remote assistance computing system (e.g., remote assistance system 426 in FIG. 4) can, at 714, transmit instructions to perform one or more of the remote assistance options based on input from a remote assistance operator. In some examples, the remote assistance operator can also initiate two-way communication with one or more passengers in the autonomous vehicle (e.g., autonomous vehicle 105 in FIG. 1).

Various means can be configured to perform the methods and processes described herein. For example, a computing system can include request receiving units(s) 812, real-time data reception units(s) 814, overlay generation units(s) 816, display unit(s) 818, transmission unit(s) 820, and/or other means for performing the operations and functions described herein. In some implementations, one or more of the units may be implemented separately. In some implementations, one or more units may be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware.

The means can be programmed to perform one or more algorithm(s) for carrying out the operations and functions described herein. For instance, the means can be configured to receive a request for remote assistance from the autonomous vehicle (e.g., autonomous vehicle 105 in FIG. 1). For example, a remote assistance computing system (e.g., remote assistance system 426 in FIG. 4) can receive a request from an autonomous vehicle (e.g., autonomous vehicle 105 in FIG. 1) that includes information about the current state of the autonomous vehicle and a particular problem to be solved. A request receiving unit 812 is one example of a means for receiving a request for remote assistance from the autonomous vehicle (e.g., autonomous vehicle 105 in FIG. 1).

The means can be configured to receive real-time video data from the autonomous vehicle (e.g., autonomous vehicle 105 in FIG. 1) and real-time telemetry data from the autonomous vehicle (e.g., autonomous vehicle 105 in FIG. 1). For example, the requesting autonomous vehicle (e.g., autonomous vehicle 105 in FIG. 1) can transmit a live video feed to the remote assistance computing system (e.g., remote assistance system 426 in FIG. 4) as well as the telemetry data it generates in analyzing the situation. A real-time data reception unit 814 is one example of a means for receiving real-time video data from the autonomous vehicle (e.g., autonomous vehicle 105 in FIG. 1) and real-time telemetry data from the autonomous vehicle (e.g., autonomous vehicle 105 in FIG. 1).

The means can be configured to generate a graphical overlay based, at least in part, on the telemetry data. For example, the remote assistance computing system (e.g., remote assistance system 426 in FIG. 4) can generate an overlay with a plurality of graphic elements, each element serving to highlight one or more aspects of the video data that is associated with the current situation of the requesting autonomous vehicle. An overlay generation unit 816 is one example of a means for generating a graphical overlay based, at least in part, on the telemetry data.

The means can be configured to display, in a remote assistance user interface, the real-time video data with the graphical overlay displayed such that it is visible over the real-time video data and display one or more remote assistance options in the remote assistance user interface, each remote assistance option is associated with a specific user interface element. For example, the remote assistance computing system (e.g., remote assistance system 426 in FIG. 4) can generate a user interface to display information to the remote assistance operator and receive input from that remote assistance operator. A display unit 818 is one example of a means for displaying, in a remote assistance user interface, the real-time video data with the graphical overlay displayed such that it is visible over the real-time video data and displaying one or more remote assistance options in the remote assistance user interface, each remote assistance option is associated with a specific user interface element.

The means can be configured to transmit instructions to perform one or more of the remote assistance options based on input from a remote assistance operator. For example, the remote assistance computing system (e.g., remote assistance system 426 in FIG. 4) can, in response to the remote operator selecting a particular remote assistance option, transmit instructions to perform the selected option such that they will be received by the autonomous vehicle. A transmission unit 820 is one example of a means for transmitting instructions to perform one or more of the remote assistance options based on input from a remote assistance operator.

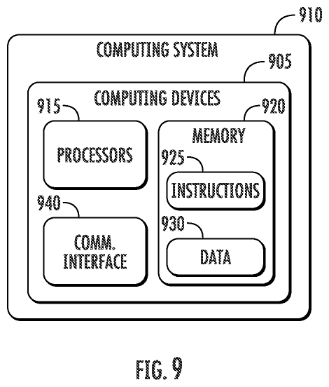

FIG. 9 depicts example system components according to example aspects of the present disclosure. The example system 900 illustrated in FIG. 9 is provided as an example only. The components, systems, connections, and/or other aspects illustrated in FIG. 9 are optional and are provided as examples of what is possible, but not required, to implement the present disclosure. The computing system 900 can be and/or include the vehicle computing system 110 of FIG. 1 or simulation system 320 of FIG. 3. The computing system 900 can be associated with an operations system and/or an entity associated with the vehicle 105 such as, for example, a vehicle owner, vehicle manager, fleet operator, service provider, etc.

The computing device(s) 905 of the computing system 900 can include processor(s) 915 and at least one memory 920. The one or more processors 915 can be any suitable processing device (e.g., a processor core, a microprocessor, an ASIC, an FPGA, a controller, a microcontroller, etc.) and can be one processor or a plurality of processors that are operatively connected. The memory 920 can include one or more non-transitory computer-readable storage media, such as RAM, ROM, EEPROM, EPROM, one or more memory devices, flash memory devices, magnetic disks, data registers, etc., and combinations thereof.

The memory 920 can store information that can be accessed by the one or more processors 915. For instance, the memory 920 (e.g., one or more non-transitory computer-readable storage mediums, memory devices) can include computer-readable instructions 925 that can be executed by the one or more processors 915. The instructions 925 can be software written in any suitable programming language or can be implemented in hardware. Additionally, or alternatively, the instructions 925 can be executed in logically and/or virtually separate threads on processor(s) 915

For example, the memory 920 on-board the vehicle 105 can store instructions 925 that when executed by the one or more processors 915 cause the one or more processors 915 (e.g., in the vehicle computing system 110) to perform operations such as any of the operations and functions of the computing device(s) 905 and/or vehicle computing system 110 (and its sub-systems (e.g., the perception, prediction, motion planner systems, etc.)), any of the operations and functions for which the vehicle computing system 110 (and/or its subsystems) are configured, any portions of the methods described herein, and/or any other operations and functions described herein. Memory for a system offboard a vehicle can store instructions to perform any operations and functions of the offboard systems described herein and/or the operations and functions of the autonomous vehicle (its computing system), methods, and/or any other operations and functions described herein.

The memory 920 can store data 930 that can be obtained (e.g., received, accessed, written, manipulated, created, generated, etc.) and/or stored. The data 930 can include, for instance, services data (e.g., trip data, route data, user data, etc.), sensor data, map data, video data, telemetry data, object data, intention data, and/or other data/information as described herein. In some implementations, the computing device(s) 905 can obtain data from one or more memories that are remote from the autonomous vehicle 105.

The computing device(s) 905 can also include a communication interface 940 used to communicate with one or more other system(s) (e.g., the remote computing system). The communication interface 940 can include any circuits, components, software, etc. for communicating via one or more networks (e.g., network(s)). In some implementations, the communication interface 940 can include, for example, one or more of: a communications controller, a receiver, a transceiver, a transmitter, a port, conductors, software, and/or hardware for communicating data.

Computing tasks discussed herein as being performed at computing device(s) remote from the autonomous vehicle can instead be performed at the autonomous vehicle (e.g., via the vehicle computing system), or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implements tasks and/or operations can be performed sequentially or in parallel. Data and instructions can be stored in a single memory device or across multiple memory devices.

Aspects of the disclosure have been described in terms of illustrative embodiments thereof. Numerous other embodiments, modifications, and/or variations within the scope and spirit of the appended claims can occur to persons of ordinary skill in the art from a review of this disclosure. Any and all features in the following claims can be combined and/or rearranged in any way possible.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and/or equivalents to such embodiments. Accordingly, the subject disclosure does not preclude inclusion of such modifications, variations, and/or additions to the present subject matter as would be readily apparent to one of ordinary skill in the art. For instance, features illustrated and/or described as part of one embodiment can be used with another embodiment to yield a still further embodiment. Thus, it is intended that the present disclosure cover such alterations, variations, and/or equivalents.

What is claimed is:

1. A computer-implemented method for improving remote operator assistance for an autonomous vehicle, the method comprising:
receiving, by a computing system with one or more processors, a request for remote assistance from the autonomous vehicle;
receiving, by the computing system, real-time video data from the autonomous vehicle;
receiving, by the computing system, real-time telemetry data from the autonomous vehicle;
generating, by the computing system, a graphical overlay based, at least in part, on the telemetry data;
displaying, by the computing system and in a remote assistance user interface, the real-time video data with the graphical overlay displayed such that it is visible over the real-time video data;
displaying, by the computing system, one or more remote assistance options in the remote assistance user interface, each remote assistance option is associated with a specific user interface element; and
transmitting, by the computing system, instructions to perform one or more of the remote assistance options based on input from a remote assistance operator.

2. The computer-implemented method of claim 1, further comprising:
synchronizing, by the computing system, the real-time video data with the real-time telemetry data.

3. The computer-implemented method of claim 2, wherein the real-time video frame comprises a plurality of video frames, each video frame in the plurality of video frames comprises timestamp data and the telemetry data is subdivided into a plurality of telemetry frames, each telemetry frame in the plurality of telemetry frame comprises telemetry data associated with a particular timestamp data.

4. The computer-implemented method of claim 3, wherein synchronizing, by the computing system, the real-time video data with the real-time telemetry data further comprises:
for a respective video frame in the plurality of video frames:
identifying, by the computing system, a telemetry frame such that the timestamp data associated with the telemetry frame is within a predetermined time of the timestamp data associated with the respective video frame; and
using, by the computing system, the identified telemetry frame to generate the graphical overlay to be displayed while the respective video frame is being displayed.

5. The computer-implemented method of claim 1, wherein the telemetry data is generated by the autonomy system of the autonomous vehicle.

6. The computer-implemented method of claim 5, wherein the telemetry data includes one or more intended actions of the autonomous vehicle.

7. The computer-implemented method of claim 6, wherein the graphical overlay includes a graphical representation of one or more intended actions of the autonomous vehicle.

8. The computer-implemented method of claim 5, wherein the telemetry data includes one or more of: a classification for one or more objects in the real-time video data and a predicted measurement of at least one parameter associated with the real-time video data.

9. The computer-implemented method of claim 8, wherein the graphical overlay includes a graphical representation of one or more of: the classification for one or more objects in the real-time video data and the predicted measurement of at least one parameter associated with the real-time video data.

10. The computer-implemented method of claim 8, wherein the remote assistance request includes data describing a particular problem and the graphical overlay includes a graphical element that highlights the particular problem.

11. The computer-implemented method of claim 1, wherein the graphical overlay includes a plurality of graphical interface elements that can be superimposed over the real-time video data in the remote assistance user interface.

12. The computer-implemented method of claim 11, the method further comprising:
receiving, by the computing device, input from a remote assistance operator on a user interface element; and
in response to receiving input from the remote assistance operator on the user interface element, removing, by the computing system, one or more graphical interface elements from the graphical overlay.

13. The computer-implemented method of claim 1, wherein each remote assistance option has associated telemetry data included in the real-time telemetry data.

14. The computer-implemented method of claim 13, wherein displaying, by the computing system, one or more remote assistance options in the remote assistance user interface, each remote assistance option is associated with a specific user interface element further comprises:
receiving, by the computing system, user interaction from the remote assistance operator with a specific user interface element associated with a particular remote assistance option; and
in response to receiving user interaction from the remote assistance operator with a specific user interface element, displaying, by the computing system, additional graphical interface elements in the graphical overlay, the additional graphical interface elements being associated with the specific user interface element.

15. A remote assistance computing system, comprising:
one or more processors; and
one or more non-transitory computer-readable media that collectively store instructions that, when executed by the one or more processors, cause the one or more processors to perform operations, the operations comprising:
receiving a request for remote assistance from an autonomous vehicle, the autonomous vehicle having an associated geological position;
receiving real-time video data from the autonomous vehicle;
receiving real-time telemetry data from the autonomous vehicle;
accessing map data of the geological position associated with the autonomous vehicle;
presenting a remote assistance interface, the remote assistance interface including a real-time video display area and a map view area, the real-time display area displaying the real-time video data and the map view area displaying the map data associated with the autonomous vehicle;
generating a graphical overlay based, at least in part, on the telemetry data;
displaying, in a remote assistance user interface, the graphical overlay displayed such that it is visible over the map;
displaying one or more remote assistance options in the remote assistance user interface, each remote assistance option is associated with a specific user interface element; and
transmitting instructions to perform one or more of the remote assistance options based on input from a remote assistance operator.

16. The remote assistance computing system of claim 15, wherein the map interface includes a motion plan for the autonomous vehicle.

17. The remote assistance computing system of claim 15, wherein the map data includes a plurality of predetermined stopping zones and the graphical overlay includes one or more selectable graphical elements displaying the position of one or more predetermined stopping zones, further comprising:
detecting selection of a selectable graphic element displaying the location of a respective predetermined stopping zone, and
updating the graphic overlay to display a path from the current position of the autonomous vehicle to the respective predetermined stopping zone.

18. A non-transitory computer-readable medium storing instruction that, when executed by one or more computing devices, cause the one or more computing devices to perform operations, the operations comprising:
receiving a request for remote assistance from an autonomous vehicle;
receiving real-time video data from the autonomous vehicle;
receiving real-time telemetry data from the autonomous vehicle;
generating a graphical overlay based, at least in part, on the telemetry data;
synchronizing the real-time video data with the real-time telemetry data;
displaying, in a remote assistance user interface, the real-time video data with the graphical overlay displayed such that it is visible over the real-time video data and appropriately synchronized with the real-time video data;
displaying one or more remote assistance options in the remote assistance user interface, each remote assistance option is associated with a specific user interface element; and
transmitting instructions to perform one or more of the remote assistance options based on input from a remote assistance operator.

19. The non-transitory computer-readable medium of claim 18, wherein the real-time video frame comprises a plurality of video frames, each video frame in the plurality of video frames includes timestamp data and the telemetry data is subdivided into a plurality of telemetry frames, each telemetry frame in the plurality of telemetry frame includes telemetry data associated with a particular timestamp data.

20. The non-transitory computer-readable medium of claim 19, wherein synchronizing the real-time video data with the real-time telemetry data further comprises:
for a respective video frame in the plurality of video frames:
identifying a telemetry frame such that the timestamp data associated with the telemetry frame is within a predetermined time of the timestamp data associated with the respective video frame; and
using the identified telemetry frame to generate the graphical overlay to be displayed while the respective video frame is being displayed.
